(19) United States
(12) Patent Application Publication
(10) Pub. No.: US 2026/0149037 A1
(43) Pub. Date: May 28, 2026

(54) SOLID ELECTROLYTE, METHOD FOR PRODUCING SOLID ELECTROLYTE, POSITIVE ELECTRODE MATERIAL, AND BATTERY

(71) Applicant: Panasonic Intellectual Property Management Co., Ltd., Osaka (JP)

(72) Inventor: Eiichi KOGA, Hokkaido (JP)

(21) Appl. No.: 19/429,619

(22) Filed: Dec. 22, 2025

Related U.S. Application Data
(63) Continuation of application No. PCT/JP2024/020792, filed on Jun. 6, 2024.

(30) Foreign Application Priority Data
Jun. 29, 2023 (JP) 2023-107589

(51) Int. Cl. H01M 10/0562

(52) U.S. Cl. CPC H01M 10/0562; H01M 2300/008

(57) ABSTRACT

A solid electrolyte of the present disclosure includes a first crystal phase represented by a composition formula (1): Li₃AlF₆ and having an orthorhombic crystal structure. A production method for a solid electrolyte of the present disclosure includes (A) mixing a raw material including at least one selected from the group consisting of an oxide of Li, a carbonate of Li, and a hydroxide of Li and at least one selected from the group consisting of an oxide of Al, a carbonate of Al, and a hydroxide of Al, and performing fluorination treatment on the mixed raw material.

This application is a continuation of PCT/JP2024/020792 filed on Jun. 6, 2024, which claims foreign priority of Japanese Patent Application No. 2023-107589 filed on Jun. 29, 2023, the entire contents of both of which are incorporated herein by reference.

### BACKGROUND OF THE INVENTION

### 1. Field of the Invention

The present disclosure relates to a solid electrolyte, a production method for a solid electrolyte, a positive electrode material, and a battery.

### 2. Description of Related Art

WO 2018/123479 discloses a lithium-ion battery including a solid electrolyte layer including Li₃AlF₆.

### SUMMARY OF THE INVENTION

The present disclosure aims to provide a novel solid electrolyte material that is highly useful.

A solid electrolyte of the present disclosure includes a first crystal phase represented by the following composition formula (1) and having an orthorhombic crystal structure.

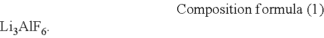

The present disclosure provides a novel solid electrolyte material that is highly useful.

### BRIEF DESCRIPTION OF THE DRAWINGS

FIG. 1 is a flowchart showing an example of a production method for a solid electrolyte according to a second embodiment.

FIG. 2 is a flowchart showing an example of a production method for a solid electrolyte according to a third embodiment.

FIG. 3 is a flowchart showing a modification of the production method for a solid electrolyte according to the third embodiment.

FIG. 4 is a flowchart showing an example of a production method for a solid electrolyte according to a fourth embodiment.

FIG. 5 is a flowchart showing an example of a production method for a solid electrolyte according to a fifth embodiment.

FIG. 6 is a flowchart showing a modification of the production method for a solid electrolyte according to the fifth embodiment.

FIG. 7 illustrates a cross-sectional view of a battery 1000 according to a sixth embodiment.

FIG. 8A is a graph showing an X-ray diffraction pattern of a solid electrolyte after heat treatment and before pulverization treatment in a production method of Example 1 and an X-ray diffraction pattern of a solid electrolyte obtained in Comparative Example 1.

FIG. 8B is a graph showing an X-ray diffraction pattern of a solid electrolyte after the pulverization treatment obtained in Example 1.

### DETAILED DESCRIPTION

Hereinafter, embodiments of the present disclosure will be specifically described with reference to the drawings.

The embodiments described below are all comprehensive or specific examples. The numerical values, shapes, materials, components, etc., shown in the following embodiments are examples, and are not intended to limit the present disclosure. In addition, among the components in the following embodiments, the components that are not described in the independent claims that represent broadest concepts are described as discretionary components.

### First Embodiment

A solid electrolyte according to a first embodiment of the present disclosure includes a first crystal phase represented by the following composition formula (1) and having an orthorhombic crystal structure.

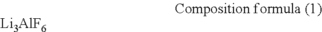

The solid electrolyte according to the first embodiment is a novel solid electrolyte that is highly useful. The solid electrolyte, which includes a first crystal phase represented by the composition formula (1): Li₃AlF₆ and having an orthorhombic crystal structure, can have characteristics of high ionic conductivity and excellent stability. The solid electrolyte having such a configuration can be synthesized, for example, at a low temperature (e.g., about 150° C. or higher and 700° C. or lower) and thus is less likely to be exposed to a high temperature for a long time during production. Accordingly, during production, the solid electrolyte does not become hard due to excessive sintering, or the particle growth of the solid electrolyte does not excessively proceed. Therefore, the solid electrolyte according to the first embodiment is soft and excellent in deformability, and further can be provided as fine particles. When such a solid electrolyte having excellent deformability as fine particles is made into a compacted powder, an interface where particles are in close contact with each other is easily formed, the solid electrolyte can be highly densified and is easily thinned, and further improvement of the ionic conductivity thereof can also be expected. Therefore, the solid electrolyte according to the first embodiment is a highly useful solid electrolyte that, when used, for example, for a solid electrolyte layer of a battery, can achieve thinning of the solid electrolyte layer or can be suitably used for a coating layer for active material particles. Therefore, with the solid electrolyte according to the first embodiment, a battery having high performance is realized. The hardness of the solid electrolyte can be compared and evaluated, for example, by a method such as Micro-Vickers measurement for particles or a compacted powder.

The solid electrolyte according to the first embodiment may be in particle form. According to this configuration, a relatively soft particulate solid electrolyte can be realized. Therefore, a compacted powder of such a solid electrolyte has high ionic conductivity and excellent stability and can take any shape. Therefore, with the compacted powder of the solid electrolyte having such characteristics, a solid electrolyte layer of a battery or a coating layer for active material particles having excellent characteristics and high reliability can be realized. Accordingly, with the solid electrolyte according to the first embodiment, a battery having high performance and high reliability is realized. The size and shape of the solid electrolyte particles can be selected as appropriate according to the application.

The solid electrolyte according to the first embodiment includes, for example, particles having a particle diameter of 1 μm or less. When the solid electrolyte according to the first embodiment includes such particles, in the case where the solid electrolyte is used for a solid electrolyte layer, further thinning of the solid electrolyte layer can be achieved, or the solid electrolyte can be more suitably used as a coating layer for active material particles. With the solid electrolyte having such a configuration, a battery having higher performance is realized.

The solid electrolyte according to the first embodiment includes, for example, particles having a particle diameter of 0.3 μm or more. When the solid electrolyte according to the first embodiment includes such particles, the ionic conductivity can be improved.

The average particle diameter of the solid electrolyte according to the first embodiment may be 1 μm or less. In the case where the solid electrolyte having such an average particle diameter is used, for example, for a solid electrolyte layer of a battery, further thinning of the solid electrolyte layer can be achieved, or the solid electrolyte can be more suitably used as a coating layer for active material particles. Therefore, when the solid electrolyte according to the first embodiment has an average particle diameter of 1 μm or less, a battery having higher performance can be realized. The average particle diameter of the solid electrolyte according to the first embodiment may be, for example, 0.1 μm or more.

The average particle diameter of the solid electrolyte is a median diameter and means a particle diameter (d50) equivalent to 50% of the cumulative volume obtained from a particle size distribution measured on a volume basis by a laser diffraction scattering method. The same applies to the average particle diameters of a raw material and a fluorine-containing substance specified in this specification.

The solid electrolyte according to the first embodiment may include particles having an aspect ratio of 2.0 or more. Here, the aspect ratio of each particle of the solid electrolyte is the ratio of the longest diameter (i.e., the length of the major axis) of the particle of the solid electrolyte to the shortest diameter (i.e., the length of the minor axis) of the particle of the solid electrolyte (length of major axis/length of minor axis).

When particles having an aspect ratio of 2.0 or more and an elongated shape are included, the solid electrolyte according to the first embodiment can have improved ionic conductivity. In addition, in the case where a slurry containing a solid electrolyte including particles having such an aspect ratio is prepared and printing or coating is performed using the slurry, the particles of the solid electrolyte are easily oriented and arranged along the printing or coating surface. Therefore, in the case where the solid electrolyte including particles having an aspect ratio of 2.0 or more is used for a solid electrolyte layer of a battery, further thinning of the solid electrolyte layer can be achieved. With the solid electrolyte including particles having an aspect ratio of 2.0 or more, a small-sized battery having a high capacity density can be realized. In addition, in the case where the solid electrolyte having such a configuration is used for a solid electrolyte layer of a battery, the resistance component of the solid electrolyte layer is reduced, so that a battery having high performance can be obtained.

The particles of the solid electrolyte according to the first embodiment may have an aspect ratio of 6.0 or less, for example.

The average aspect ratio of the solid electrolyte according to the first embodiment may be 2.0 or more. In addition, the average aspect ratio of the solid electrolyte according to the first embodiment may be 3.0 or less.

Here, the aspect ratio of each particle of the solid electrolyte can be obtained from a scanning electron microscope (SEM) image of the solid electrolyte obtained by an SEM. That is, the aspect ratio of each particle is calculated by identifying the shortest diameter and the longest diameter of the particle from an SEM image of the particle of the solid electrolyte. The average aspect ratio can be obtained by obtaining the aspect ratios of 50 particles arbitrarily extracted from an SEM image of the solid electrolyte and calculating the average value of these aspect ratios.

The solid electrolyte according to the first embodiment may include particles having a free surface. Owing to this configuration, the solid electrolyte according to the first embodiment can have excellent stability in atmospheric air. Here, in the present disclosure, the free surface of the solid electrolyte means the surface of the solid electrolyte in a synthesized state (i.e., a surface having high stability) and does not include an active surface, inside the solid electrolyte, that is highly reactive and that is exposed by pulverization or the like.

The solid electrolyte according to the first embodiment may be an Li₃AlF₆ solid solution including a first crystal phase represented by the composition formula (1): Li₃AlF₆ and having an orthorhombic crystal structure.

The solid electrolyte according to the first embodiment may further include a second crystal phase represented by the composition formula (1): Li₃AlF₆ and having a monoclinic crystal structure. Owing to this configuration, a softer solid electrolyte having more excellent deformability can be obtained. As described above, when the softer solid electrolyte having more excellent deformability is made into a compacted powder, an interface where particles are in close contact with each other is easily formed, the solid electrolyte can be highly densified and is easily thinned, and further improvement of the ionic conductivity thereof can also be expected. Therefore, in the case where the solid electrolyte further including the second crystal phase is used for a solid electrolyte layer of a battery and a coating layer for active material particles, a solid electrolyte layer and a coating layer which have a high quality and in which defects such as voids are suppressed can be formed. Therefore, with the solid electrolyte according to the first embodiment, a battery having higher performance and excellent reliability can be realized. The solid electrolyte according to the first embodiment may be an Li₃AlF₆ solid solution including a first crystal phase and a second crystal phase.

The solid electrolyte according to the first embodiment may include first particles that include a first crystal phase and do not include a second crystal phase, and second particles that include a second crystal phase. In this case, the second particles are softer than the first particles. Here, in the present disclosure, the hardnesses of the first particles and the second particles can be compared and evaluated, for example, by Micro-Vickers measurement, for these particles or compacted powders of these particles.

The first crystal phase tends to have a higher ionic conductivity than the second crystal phase. For example, a solid electrolyte composed of the first crystal phase can achieve, for example, an ionic conductivity of more than 3 μS/cm in a compacted powder thereof. Meanwhile, the ionic conductivity of a solid electrolyte composed of the second crystal phase is, for example, about 1 μS/cm or more and 2 μS/cm or less in a compacted powder thereof.

When the solid electrolyte according to the first embodiment includes the first particles and the second particles, the softness and the deformability thereof are further improved. As described, when the softer solid electrolyte having more excellent deformability is made into a compacted powder, an interface where particles are in close contact with each other is easily formed, the solid electrolyte can be highly densified and is easily thinned, and further improvement of the ionic conductivity thereof can also be expected. Furthermore, heat shock resistance during a thermal cycle, etc., is also improved. Therefore, by having such a configuration, a battery having higher performance and excellent reliability can be realized in the case where the solid electrolyte according to the first embodiment is used for a battery.

The solid electrolyte according to the first embodiment may include an amorphous phase. Owing to this configuration, the amorphized part of the solid electrolyte becomes softer, has more excellent deformability, and has improved interparticle bonding. Therefore, with a compacted powder of the solid electrolyte according to the first embodiment, a solid electrolyte layer having higher ionic conductivity and higher stability can be formed in any shape. Thus, in the case where the solid electrolyte according to the first embodiment includes an amorphous phase, a solid electrolyte layer of a battery or a coating layer for active material particles which has excellent characteristics and high reliability can be realized with a compacted powder of the solid electrolyte. As a result, a battery having high performance and high reliability is realized.

The solid electrolyte according to the first embodiment may further contain at least one selected from the group consisting of Ti, Si, Cu, and Ga as a secondary component. That is, in this case, the solid electrolyte according to the first embodiment is a solid electrolyte that includes a crystal phase represented by the composition formula (1): Li₃AlF₆ and having an orthorhombic crystal structure and that further contains at least one selected from the group consisting of Ti, Si, Cu, and Ga. Owing to this configuration, a homogeneous solid electrolyte having excellent ionic conductivity is obtained.

The above element contained as the secondary component (i.e., at least one selected from the group consisting of Ti, Si, Cu, and Ga) may be derived from a substance added as an additive for promoting the reaction of the raw material when synthesizing the solid electrolyte according to the first embodiment, for example. In addition, in X-ray diffraction measurement of the solid electrolyte according to the first embodiment, Ti, Si, Cu, and Ga are not detected as composition phases in some cases. Even in such a case, the fact that the solid electrolyte contains Ti, Si, Cu, and Ga can be confirmed by high-sensitivity compositional analysis (area analysis or the like) such as by using an electron probe microanalyzer (EPMA). The total of the content ratios of Ti, Si, Cu, and Ga contained in the solid electrolyte may be, for example, 0.0003 at. % or more and 0.15 at. % or less. The content ratios of Ti, Si, Cu, and Ga can be obtained by EPMA or the like.

When the solid electrolyte according to the first embodiment is compared with the solid electrolyte described in WO 2018/123479, there are differences, as described below.

WO 2018/123479 discloses Li₃AlF₆ as an example of a second solid electrolyte which is a secondary component included in a solid electrolyte layer of a lithium-ion battery. WO 2018/123479 does not describe a crystal structure, but it is determined that Li₃AlF₆ is synthesized by a known method, since a synthesis method, etc., are not described in WO 2018/123479. That is, Li₃AlF₆ disclosed in WO 2018/123479 is considered to have a monoclinic crystal structure. In addition, from the description of WO 2018/123479, Li₃AlF₆ disclosed in WO 2018/123479 is also not considered to be amorphized. For this reason, Li₃AlF₆ disclosed as a second solid electrolyte in WO 2018/123479 is not Li₃AlF₆ having an orthorhombic crystal structure as in the solid electrolyte according to the first embodiment, and as a matter of course, it is difficult to obtain a high ionic conductivity as in the solid electrolyte according to the first embodiment. In addition, Li₃AlF₆ disclosed as a second solid electrolyte in WO 2018/123479 is considered not to be as highly useful as the solid electrolyte according to the first embodiment in that the latter is soft and has excellent deformability, an interface where particles are in close contact with each other is easily formed when the latter is made into a compacted powder, and the latter can be highly densified and is easily thinned, like the solid electrolyte according to the first embodiment.

### Second Embodiment

Hereinafter, a production method for a solid electrolyte according to a second embodiment will be described.

The solid electrolyte produced by the production method according to the second embodiment is the solid electrolyte according to the first embodiment. That is, the production method according to the second embodiment is a production method for a solid electrolyte including a first crystal phase represented by the composition formula (1): Li₃AlF₆ and having an orthorhombic crystal structure.

The production method according to the second embodiment includes

(A) mixing a raw material including at least one selected from the group consisting of an oxide of Li, a carbonate of Li, and a hydroxide of Li and at least one selected from the group consisting of an oxide of Al, a carbonate of Al, and a hydroxide of Al, and performing fluorination treatment on the mixed raw material.

The production method according to the second embodiment uses relatively stable oxides, carbonates, and hydroxides as the raw material and causes fluorination of the raw material and a solid-phase reaction to occur simultaneously, so that a solid electrolyte including a first crystal phase represented by the composition formula (1): Li₃AlF₆ and having an orthorhombic crystal structure can be synthesized. In addition, with this production method, a solid electrolyte including a first crystal phase represented by the composition formula (1): Li₃AlF₆ and having an orthorhombic crystal structure can be synthesized at a low temperature (e.g., a temperature of about 150° C. or higher and 700° C. or lower) at which synthesis is impossible in a solid-phase reaction using a fluoride raw material. In addition, with this production method, a solid electrolyte having a desired composition can be accurately produced by controlling the ratio of each component of the raw material. Therefore, with the production method according to the second embodiment, a solid electrolyte including a crystal phase represented by the composition formula (1): Li₃AlF₆ and having an orthorhombic crystal structure is easily produced stably at a low cost and can be produced with good reproducibility.

For example, when Li₃AlF₆ having an orthorhombic crystal structure and synthesized by the production method according to the second embodiment is made into a compacted powder at a certain pressure, the density of the compacted powder can be shown to be 1.92 g/cm³ or more and 1.98 g/cm³ or less, as an example. This is substantially the same as or larger than a density of 1.81 g/cm³ or more and 1.94 g/cm³ or less of a compacted powder that can be realized by making Li₃AlF₆, which has a monoclinic crystal structure and is obtained by solid-phase synthesis from a fluoride using the fluoride as a raw material, into a compacted powder at the same pressure.

In the above (A), the fluorination treatment on the raw material may be performed, for example, by performing heat treatment on a fluorine-containing substance having thermal decomposition properties.

By performing the fluorination treatment on the raw material through the heat treatment on the fluorine-containing substance having thermal decomposition properties, fluorination of the raw material and a solid-phase reaction for synthesizing the solid electrolyte can be caused to occur simultaneously, and a solid electrolyte including a first crystal phase represented by the composition formula (1): Li₃AlF₆ and having an orthorhombic crystal structure can be synthesized. Therefore, a homogeneous solid electrolyte having excellent characteristics can be obtained in a short time while reducing reaction residues such as oxides. Furthermore, for example, the temperatures of the fluorination reaction and the solid-phase reaction of the raw material and the progress of these reactions can also be controlled according to the thermal decomposition temperature of the fluorine-containing substance to be selected. Thus, fluorination treatment suitable for various raw materials can be performed.

When a fluorine-containing substance having thermal decomposition properties is used for the fluorination treatment on the raw material, in the production method according to the second embodiment, the above (A) may include
(A-1) mixing the raw material and the fluorine-containing substance, and
(A-2) fluorinating the raw material by performing heat treatment on a mixture including the raw material and the fluorine-containing substance obtained in the above (A-1), to obtain the solid electrolyte.

In the production method according to the second embodiment, by performing the above (A-1) and the above (A-2), the heat treatment for the fluorination treatment can be performed on a homogeneous mixture obtained by mixing the raw material and the fluorine-containing substance. In addition, the contact area between the raw material and the fluorine-containing substance can be increased. Accordingly, the fluorination of the raw material is uniformly promoted, and thus a homogeneous solid electrolyte having excellent characteristics can be obtained with high productivity.

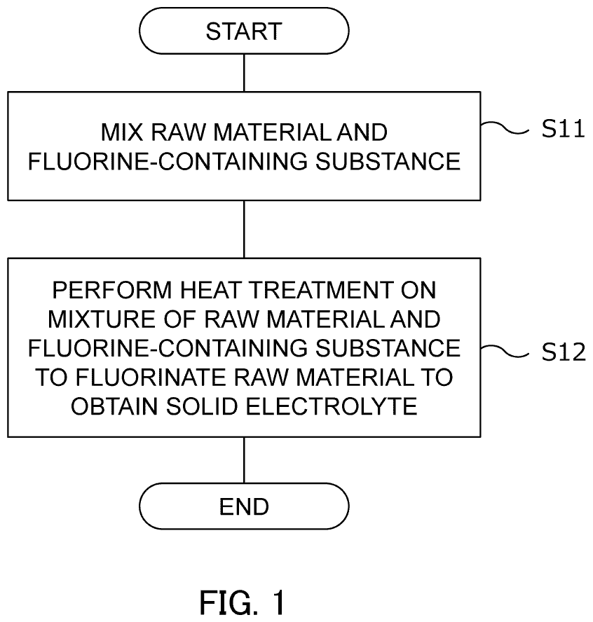

FIG. 1 is a flowchart showing an example of the production method for a solid electrolyte according to the second embodiment. Here, an example of a production method in which the above (A-1) and the above (A-2) are performed will be described as an example of the production method according to the second embodiment.

As shown in FIG. 1, in an example of the production method according to the second embodiment, first, as a step corresponding to the above (A-1), a raw material and a fluorine-containing substance are mixed (S11). As described above, the raw material includes at least one selected from the group consisting of an oxide of Li, a carbonate of Li, and a hydroxide of Li and at least one selected from the group consisting of an oxide of Al, a carbonate of Al, and a hydroxide of Al. The fluorine-containing substance has thermal decomposition properties. Next, as a step corresponding to the above (A-2), the raw material is fluorinated by performing heat treatment on the obtained mixture including the raw material and the fluorine-containing substance (S12). Accordingly, a solid electrolyte including a first crystal phase represented by the composition formula (1): Li₃AlF₆ and having an orthorhombic crystal structure is obtained.

Hereinafter, the raw material, the fluorine-containing substance, and the steps corresponding to the above (A-1) and the above (A-2), respectively, will be specifically described.

### <Raw Material>

The raw material includes at least one selected from the group consisting of an oxide of Li, a carbonate of Li, and a hydroxide of Li and at least one selected from the group consisting of an oxide of Al, a carbonate of Al, and a hydroxide of Al.

The fluorination of the raw material progresses from the surface thereof, and thus the raw material may be, for example, in particle form. Accordingly, it becomes easier for fluorination (i.e., substitution of fluorine and oxygen elements) from the particle surface of the raw material and the solid-phase reaction in the raw material to occur simultaneously. Therefore, a fluoride can be synthesized in a short time while reducing reaction residues such as oxides. Thus, a homogeneous solid electrolyte having excellent characteristics can be obtained. In addition, the particulate raw material has good reactivity such as fluorination properties and solid-phase reactivity, and thus excellent productivity can also be achieved. Moreover, when the raw material is in particle form, the raw material is easily mixed homogeneously with the fluorine-containing substance, so that the fluorination of the raw material progresses uniformly, and a solid electrolyte having good characteristics can be synthesized.

For synthesizing fine Li₃AlF₆ having an orthorhombic crystal structure, using small particles as an Al source included in the raw material is suitable. For example, at least one selected from the group consisting of an oxide of Al, a carbonate of Al, and a hydroxide of Al, which is used as an Al source, may have an average particle diameter of 0.06 μm or more and 1.0 μm or less, for example. In addition, at least one selected from the group consisting of an oxide of Al, a carbonate of Al, and a hydroxide of Al, which is used as an Al source, may have a BET specific surface area of 3 m²/g or more and 30 m²/g or less, for example. The Al source having such a BET specific surface area is suitable for the fluorination treatment. Therefore, when the Al source having such a configuration is used as the raw material, it becomes easier for the fluorination reaction and the solid-phase reaction to occur simultaneously.

The average particle diameter of an Li source included in the raw material is not particularly limited, but may be, for example, 1 μm or more and 20 μm or less. An Li source having an appropriate size can be selected in view of the stability, characteristics, and handling in the production process of the solid electrolyte to be synthesized.

The raw material may be subjected to pulverization treatment for each individual substance, in advance. The reactivity of the raw material can be increased by decreasing the particle diameter of the raw material or by exposing fracture surfaces of the particles through pulverization treatment. The fracture surfaces of the particle have higher activity than non-fractured surfaces thereof. The introduction of the pulverization treatment to the raw material may be adjusted as appropriate from the viewpoint of the stability of synthesis and the characteristics of the solid electrolyte. In addition, the raw material may be a mixture of pulverized powder and non-pulverized powder. A part of the raw material may include pulverized powder. The fracture surface of the pulverized powder of the raw material can be observed from a state different from the free surface, by SEM observation of the powder.

The raw material as a whole may have an average particle diameter of 0.1 μm or more and 20 μm or less or may have an average particle diameter of 0.5 μm or more and 20 μm or less, for example. The average particle diameter of a composite oxide included in the raw material may be 0.1 μm or more and 20 μm or less, or may be 0.5 μm or more and 20 μm or less, for example. The raw material may be further micronized and may have, for example, an average particle diameter of 0.1 μm or more and 1.0 μm or less. The average particle diameter of the composite oxide included in the raw material may also be, for example, an average particle diameter of 0.1 μm or more and 1.0 μm or less. However, the average particle diameter of the raw material is not limited to the above range, and any particle diameter and shape can be selected as appropriate from the viewpoint of fluorination and solid-phase reaction. For example, the smaller the particle diameter of the raw material is, the lower the conversion temperature into the fluoride can be made.

### <Fluorine-Containing Substance>

The fluorine-containing substance has thermal decomposition properties.

The thermal decomposition-starting temperature of the fluorine-containing substance to be used may be, for example, 100° C. or higher and 600° C. or lower. When the fluorine-containing substance has a thermal decomposition-starting temperature within the above temperature range, the fluorine-containing substance can have stability in storage and handling such as mixing, and the obtained solid electrolyte can be prevented from becoming excessively hard.

The fluorine-containing substance may be, for example, in particle form. Accordingly, the fluorine-containing substance easily becomes thermally decomposed. Therefore, by using the particulate fluorine-containing substance, the raw material can be efficiently fluorinated, and the fluorine-containing substance is less likely to remain in the finally obtained solid electrolyte. In addition, the fluorination reaction can be controlled by the particle shape of the fluorine-containing substance. For example, by making the particles of the fluorine-containing substance smaller, the temperature of the fluorination can be decreased, or the rate of the fluorination can be increased. In addition, by mixing the raw material and the fluorine-containing substance, uniform fluorination of the entire powder is enabled. Moreover, precise control of the fluorine amount is enabled. Thus, the synthesis of the desired solid electrolyte is enabled. In addition, the fluorine-containing substance can be used in an amount required for the fluorination of the raw material, so that, unlike the case where fluorine gas is introduced and used in a furnace, excess fluorine gas emission can be suppressed. Therefore, the environmental impact is reduced and the influence on corrosion of a furnace material, etc., is also reduced.

The fluorine-containing substance, for example, may have an average particle diameter of 0.5 μm or more and 500 μm or less, may have an average particle diameter of 0.5 μm or more and 150 μm or less, or may have an average particle diameter of 0.5 μm or more and 100 μm or less. As with the raw material, the fluorine-containing substance may also have any particle diameter and shape.

The average particle diameter of the fluorine-containing substance may be larger than the average particle diameter of the raw material. This results in a bulkier and fluffier state of a mixed powder of the raw material and the fluorine-containing substance. That is, this results in a state where the surface exposure area (i.e., exposure area) of the raw material is larger, and the contact points between the raw material particles are reduced. The fluorine in the fluorine-containing substance reacts with the particles of the raw material in a thermally-decomposed gas state. Thus, it becomes easier for fluorination to progress from the particle surface of the raw material, so that a homogeneous fluoride solid electrolyte can be obtained. Moreover, since the contact points between the particles of the raw material become discontinuous (i.e., the contact points between the particles of the raw material are reduced), after the fluorine-containing substance decomposes and disappears, the necking between the particles during the fluorination reaction and the solid-phase reaction is interrupted. Therefore, a solid electrolyte having fine particles can be synthesized. The average particle diameter of the fluorine-containing substance may be 5 μm or more and 150 μm or less, may be 5 μm or more and 100 μm or less, may be 5 μm or more and 20 μm or less, may be 50 μm or more and 100 μm or less, or may be 80 μm or more and 150 μm or less. The average particle diameter of the fluorine-containing substance can be adjusted as appropriate in consideration of the temperature or reactivity of fluorination. For example, by increasing the average particle diameter of the fluorine-containing substance, the heat treatment temperature for the fluorination treatment is increased.

The fluorine-containing substance may include ammonium fluoride (NH₄F). The thermal decomposition of ammonium fluoride starts at a relatively low temperature (e.g., about 150° C.). Therefore, ammonium fluoride is less likely to remain as an unnecessary inorganic component in the finally obtained solid electrolyte and can be thermally decomposed at a low temperature to fluorinate the raw material. Thus, in the above production method, the fluorine-containing substance is effective for fluorinating the raw material at a low temperature (e.g., about 150 to 200° C.). Accordingly, according to the above production method, the solid electrolyte to be produced can be inhibited from being sintered and becoming hard, or the particle growth of the solid electrolyte can be inhibited from excessively proceeding. Therefore, a solid electrolyte including a first crystal phase represented by the composition formula (1): Li₃AlF₆ and having an orthorhombic crystal structure, which is softer, has more excellent deformability, and is in fine particle form, is obtained. Accordingly, the solid electrolyte obtained by the above production method easily achieves densification and thinning of a compacted powder thereof. For example, when the solid electrolyte obtained by the above production method is used for a solid electrolyte layer of a battery, further thinning and higher ionic conductivity of the solid electrolyte layer can be achieved, or the solid electrolyte can be suitably used for a coating layer for active material particles to achieve higher ionic conductivity of an electrode. Therefore, with the solid electrolyte produced by the above production method, a battery having higher performance is realized. Unnecessary inorganic components derived from the fluorine-containing substance can be inhibited from remaining in the finally obtained solid electrolyte. When a solid-phase reaction of the fluoride raw material is caused, it is difficult to generate a solid electrolyte including a crystal phase represented by the composition formula (1): Li₃AlF₆, for example, at a low temperature of about 150° C. or higher and 700° C. or lower, and at least a temperature higher than 700° C. (e.g., a temperature of about 750° C. to 800° C.) is required. Therefore, when a solid-phase reaction of the fluoride raw material is caused, it is difficult to obtain a soft and fine solid electrolyte including a crystal phase represented by the composition formula (1): Li₃AlF₆.

Furthermore, by using ammonium fluoride as the fluorine-containing substance, the energy for synthesis is saved, and the heating and cooling times are reduced, so that the productivity is also improved. Moreover, since the synthesis of the solid electrolyte at a low temperature is possible, the durability of the furnace material is improved, and the running cost and replacement frequency of a synthetic member are also significantly reduced. Only an ammonium salt may be used as the fluorine-containing substance.

The fluorine-containing substance may include a resin. By including a resin as the fluorine-containing substance, the fluorine-containing substance can fluorinate the raw material while being thermally decomposed at a relatively high temperature (e.g., about 400° C. or higher and 600° C. or lower). Therefore, the method in which the resin is included as the fluorine-containing substance is suitable for the case where it is desired to carry out the fluorination and the solid-phase reaction at a relatively high temperature (e.g., about 400° C. or higher and 600° C. or lower).

An example of the resin used as the fluorine-containing substance is a fluorine resin. For example, polytetrafluoroethylene (PTFE), polyvinylidene fluoride (PVDF), etc., can be used. The fluorine resin such as PTFE and PVDF can fluorinate the raw material while being thermally decomposed at a relatively high temperature (e.g., about 400° C. or higher and 600° C. or lower). Therefore, the method in which the fluorine resin is used as the fluorine-containing substance is suitable for the case where it is desired to carry out the fluorination and the solid-phase reaction at a relatively high temperature. For example, the case of PVDF is suitable for fluorination at 400° C. or higher, and the case of PTFE is suitable for fluorination at 500° C. or higher.

The fluorine-containing substance may include, for example, a substance from which the inorganic components generated by thermal decomposition during the heat treatment in the above (A), other than the fluorine element, are substantially not incorporated into the produced solid electrolyte. For the fluorine-containing substance used for the fluorination treatment, it is required that while the fluorine element generated by thermal decomposition during the heat treatment in the above (A) is replacing the oxygen element of the raw material, the other components are not incorporated as inorganic residues into the finally obtained solid electrolyte. By using, as the fluorine-containing substance, a substance from which the inorganic components generated by thermal decomposition during the heat treatment, other than the fluorine element, are substantially not incorporated into the finally obtained solid electrolyte, the incorporation of inorganic residues into the solid electrolyte can be suppressed, and the desired solid electrolyte can be obtained. Here, in this description, “the inorganic components generated by thermal decomposition during the heat treatment, other than the fluorine element, are substantially not incorporated into the produced solid electrolyte” means that the content ratio of the inorganic components in the solid electrolyte is 0.5 mass % or less.

The fluorine-containing substance may include a plurality of types of fluorine-containing compounds. For example, by using a plurality of types of fluorine-containing compounds having thermal decomposition properties different from each other, or by using a plurality of types of fluorine-containing compounds having particle sizes different from each other, the fluorination of the raw material can be appropriately performed. For example, both ammonium fluoride and the fluorine resin may be used as the fluorine-containing substance. Accordingly, the temperature range where the fluorine-containing substance acts as a fluorine source can be controlled to be wide, and thus the conversion of the raw material into the fluoride and the solid-phase reaction temperature can be controlled over a wide range. Therefore, it becomes easy to obtain the desired solid electrolyte.

The amount of the used fluorine-containing substance only has to be sufficient to fluorinate the entire amount of the compound to be fluorinated and is not particularly limited. For example, when the molar amount of the fluorine-containing substance for fluorinating all of the compound stoichiometrically (i.e., the molar amount equivalent stoichiometrically, in other words, the molar amount required to completely substitute the anion of the compound to be fluorinated with an F anion) in the reaction of fluorinating the compound to be fluorinated is defined as 100%, the amount of the fluorine-containing substance may be, for example 103% or more and 150% or less, may be 103% or more and 130% or less, or may be 103% or more and 110% or less.

### <(A-1)>

In (A-1), the raw material and the fluorine-containing substance are mixed.

Before the fluorination treatment, a step of uniformly mixing the raw material may be performed as a first preliminary step. In addition, a step of uniformly mixing the mixed raw material and the fluorine-containing substance may be performed as a second preliminary step. By the first preliminary step and the second preliminary step, the conversion from the raw material into the fluoride can be caused to uniformly occur. Accordingly, a homogeneous solid electrolyte can be synthesized.

In the first preliminary step, pulverization treatment of the raw material may be performed. As described above, the reactivity of the raw material can be increased by pulverizing the mixed powder of the raw material to decrease the particle diameter of the raw material, or by exposing fracture surfaces of the particles through pulverization treatment. In addition, by the pulverization treatment of the raw material, the mixability of the raw material and even the mixability between the raw material and the fluorine-containing substance can be improved. Furthermore, the particle shape of the solid electrolyte to be produced can be controlled, and, for example, fine particle formation of the solid electrolyte can be achieved. An example of the average particle diameter of the raw material is as described above.

The mixing in the first preliminary step may be dry mixing or wet mixing since the raw material only has to be homogenized. In the wet mixing, a known general dispersant can be used for the purpose of uniform mixing and increasing the treatment amount (i.e., increasing the solid content of a slurry). Examples of known dispersants include ammonium polycarboxylate-based dispersants and non-ionic surfactants. By making fine particles and causing the particles to expose fractured active surfaces through the pulverization treatment, the reactivity of the raw material after the fluorination treatment is improved. Therefore, synthesis at a low temperature and homogenization of the reaction become possible. Thus, a solid electrolyte including a crystal phase represented by the composition formula (1): Li₃AlF₆ and having an orthorhombic crystal structure, which is soft and has excellent deformability, is easily produced and can be obtained.

In the second preliminary step, pulverization treatment may be performed for the purpose of adjusting the particle size of the fluorine-containing substance. By micronizing a mixed powder including the raw material and the fluorine-containing substance, the synthesis temperature of the solid electrolyte can be decreased, for example, by about 10° C. to 50° C. Therefore, the sintering and the particle growth of the solid electrolyte can be further suppressed, so that a softer and finer solid electrolyte can be obtained.

In the second preliminary step, for example, the powders of the raw material and the fluorine-containing substance only have to be mixed such that these powders are homogeneous. For example, these powders may be uniformly mixed by repeated mixing with a spatula, or may be mixed using a mortar and a pestle, a grinding machine, a dry mixing device such as a V-blender, or the like. Alternatively, these powders may be mixed using a medium such as zirconia balls and be pulverized if necessary. As long as these powders can be mixed uniformly, any mixing means may be used. Uniformity can be evaluated, for example, using energy dispersive X-ray spectroscopy (EDS) or an electron probe microanalyzer (EPMA). For example, uniformity can be confirmed by observing a compositional mapping image.

### <(A-2)>

In (A-2), the fluorination treatment is performed on the raw material by performing the heat treatment on a mixture including the raw material and the fluorine-containing substance obtained in the above (A-1).

For the heat treatment, a general electric furnace may be used. If necessary, an atmosphere for the heat treatment may be selected, and the heat treatment may be performed in atmospheric air, an inert gas atmosphere (e.g., nitrogen gas or argon gas), or a reducing gas (e.g., hydrogen or carbon dioxide). The synthesized fluoride is normally obtained as a powder, but when the heat treatment is performed at a temperature equal to or higher than the melting point thereof, the fluoride may be obtained as a block-like mass formed by the adhesion of melts, sintered bodies, or powder.

In the heat treatment, for example, the above-described uniformly mixed mixture is placed in a heat-resistant container (sagger) made of alumina, and the mixture is fired using a firing furnace in any atmosphere. For example, an inert gas such as nitrogen gas is caused to flow into the furnace, and heat treatment is performed in the atmosphere furnace, for example, at a temperature of 150° C. or higher and 700° C. or lower, for example, for a time of 1 hour or longer and 40 hours or shorter, while the gases generated by fluorination (e.g., ammonium, hydrogen chloride, carbon dioxide, etc.) are discharged, to synthesize a solid electrolyte including a first crystal phase represented by the composition formula (1): Li₃AlF₆ and having an orthorhombic crystal structure. As described above, by introducing the gas into the firing furnace and discharging the gases therefrom, unnecessary reactive gas components, etc., are prevented from remaining in the furnace, that is, in the solid electrolyte.

It is preferable that the inert gas is introduced into the furnace such that the inert gas does not directly hit the sagger in which the mixture has been placed. Instead of the inert gas, atmospheric air may be introduced into the furnace. A plate larger than a gas introduction port is installed between the gas introduction port and the sagger. The thickness of the plate may be such a thickness that the plate is not damaged by gas flow or handling. For example, it is more preferable to partially shield by merely standing a plate such as an alumina plate upright. As a result of shielding between the gas introduction port and the sagger as described above, the gas comes into contact with the sagger after flowing around the shielding plate. By bringing the gas into indirect contact with the sagger after bypassing as described above, a problem that the temperature is decreased in the portion where the gas directly hits and the temperature distribution in the sagger is increased is reduced. Accordingly, nonuniformity of the distribution of a reaction progress (i.e., variation in the reaction progress) for the synthesis reaction of the solid electrolyte by the fluorination reaction and the solid-phase reaction of the raw material is suppressed.

It is preferable that the gas introduction port is installed on the bottom side of the furnace and an exhaust port is provided on the upper side (e.g., on the ceiling side or on the upper side of a side wall). Accordingly, the reactive gases can be smoothly discharged out of the furnace by utilizing the convection (bottom-to-top) flow in the furnace, so that incorporation of unnecessary residual components into the solid electrolyte can be reduced.

The gas to be introduced may be heated and then introduced into the furnace. Accordingly, nonuniformity of the temperature distribution in the sagger can be suppressed. Therefore, the synthesis reaction of the solid electrolyte is performed uniformly, so that a more homogeneous solid electrolyte can be obtained.

The heat treatment temperature is, for example, 150° C. or higher and 700° C. or lower as described above. The heat treatment time is, for example, 1 hour or longer and 40 hours or shorter as described above. When the heat treatment temperature is lowered and the treatment time is shortened, the sintering and the particle growth of the solid electrolyte do not proceed, so that a solid electrolyte composed of soft fine particles can be obtained. With the production method according to the second embodiment, a solid electrolyte represented by the composition formula (1): Li₃AlF₆ can be synthesized at a lower temperature than in a conventional method of synthesis by causing a solid-phase reaction of a fluoride. Therefore, with the production method according to the second embodiment, a solid electrolyte composed of soft fine particles can be obtained compared with a solid electrolyte synthesized by the conventional method. Through such production, a solid electrolyte with which a dense compacted powder having excellent ionic conductivity can be formed can be obtained.

The heat treatment temperature and heat treatment time can be determined as desired in consideration of the properties (e.g., crystal system, powder characteristics, etc.) of the raw material, the properties (e.g., crystal system, powder characteristics, etc.) of the solid electrolyte to be synthesized, the temperature required for the synthesis of a solid electrolyte including a first crystal phase represented by the composition formula (1): Li₃AlF₆ and having an orthorhombic crystal structure, the time required for the synthesis, the discharge time of the reactive gases, etc.

Under the heat treatment conditions for the fluorination treatment on the raw material in the production method according to the second embodiment, a solid electrolyte including a first crystal phase represented by the composition formula (1): Li₃AlF₆ and having an orthorhombic crystal structure is synthesized, which is difficult with the conventional method of synthesis by causing a solid-phase reaction of a fluoride. Here, depending on the fluorination conditions, a second crystal phase represented by the composition formula (1): Li₃AlF₆ and having a monoclinic crystal structure can also be generated. As an example, a solid electrolyte including a second crystal phase that is monoclinic can be synthesized at a lower temperature (e.g., 150° C. or higher and 200° C. or lower), also depending on the particle sizes of the raw material and the fluorine-containing substance. By micronizing the raw material and the fluorine-containing substance, the temperature at which the crystal systems of the raw material and the fluorine-containing substance change is lowered in a range of 10° C. or higher and 50° C. or lower, for example. Since the second crystal phase is generated by heat treatment at a lower temperature, the sintering and the particle growth of the solid electrolyte including the second crystal phase in addition to the first crystal phase are suppressed during synthesis. Therefore, the solid electrolyte further including the second crystal phase as a result of performing heat treatment at a low temperature can be obtained as a softer powder.

As the furnace used for the heat treatment, a known firing furnace (e.g., electric furnace) or an atmosphere firing furnace can be used. In order to remove the atmospheric air and moisture between the particles deep in the sagger and completely replace the atmospheric air and moisture with the inert gas, the inert gas may be caused to flow after vacuum replacement. Accordingly, the influence of reactive components and moisture contained in the atmospheric air can be reduced. Vacuum replacement may be performed repeatedly.

The temperature distribution in the sagger during the heat treatment may be within the temperature distribution range of a generally used firing furnace, for example, 30° C. The temperature distribution in the sagger here is the difference between the highest temperature and the lowest temperature in the sagger.

As described above, the fluorination treatment can be performed at a relatively low temperature, and thus the materials used as the raw material are less likely to evaporate at the temperature of the fluorination treatment. Therefore, for the fluorination treatment, the heat treatment does not need to be performed in a sealed environment. The mixture of the raw material and the fluorine-containing substance may be placed in the sagger, a lid (e.g., an alumina lid) to prevent debris and foreign objects from falling may be placed if necessary, and the heat treatment may be performed. Therefore, the heat treatment in the production method according to the second embodiment has very good productivity and workability and possesses significant industrial applicability. With the production method according to the second embodiment, a solid electrolyte including a first crystal phase represented by the composition formula (1): Li₃AlF₆ and having an orthorhombic crystal structure, and having excellent ionic conductivity and stability (e.g., electrochemical stability and heat resistance), can be obtained since the method is such a production method having excellent productivity.

The material of the sagger does not have to be alumina. As the sagger, heat-resistant containers made of various dense (e.g., relative density of 98% or more) materials such as mullite and SiC in addition to alumina can be used. From the viewpoint of the reaction between the raw material, the fluorine-containing substance, and the solid electrolyte accommodated in the sagger and the sagger, a material suitable for the sagger may be selected. In addition to the above-described materials for the sagger, those that are dense, have heat resistance, and have a small heat capacity can be used as the material of the sagger. As the shape of the sagger, various shapes such as a cylindrical shape, a prismatic shape, and a gourd shape can be used.

Here, the example in which the sagger is used for the heat treatment has been described, but the present disclosure is not limited to this. For example, a rotary furnace such as a rotary kiln may be used, or a mixed powder may be sprayed to perform heat treatment, such as spray drying.

As an example of the production method according to the first embodiment, the method in which the above (A-1) and the above (A-2) are performed has been described in detail, but the step of uniformly mixing the raw material and the fluorine-containing substance in advance before the fluorination treatment does not necessarily have to be performed. For example, the fluorine-containing substance may be added to the raw material, and the heat treatment may be performed without sufficient mixing. In addition, it is desirable to perform the heat treatment for efficient fluorination treatment, but by adding the fluorine-containing substance to the raw material and then leaving the raw material at room temperature for a long time, the fluorination of the raw material may be performed.

The surface of the solid electrolyte synthesized by the fluorination treatment and not subsequently subjected to pulverization treatment as in a production method according to a third embodiment described later is a free surface. The free surface is not an active surface that is highly reactive and that is exposed after pulverization, and thus the stability of the surface is high. Such a solid electrolyte is stable and particularly has excellent environmental resistance (storage characteristics). Therefore, depending on the application and requirements, a pulverization step after fluorination can be omitted or added as appropriate, for example, pulverization treatment can be performed after long-term storage.

In the production method according to the second embodiment, an additive may be added to the raw material if necessary before the fluorination treatment. For example, an additive for promoting the fluorination reaction of the raw material, an additive for promoting the solid-phase reaction of the raw material, etc., may be added. Examples of such additives include a compound (e.g., an oxide) containing at least one element selected from the group consisting of Ti, Si, Cu, Ga, Zn, Mg, Nb, P, K, Na, Ca, and Fe. For example, when a Ti oxide, an Si oxide, a Cu oxide, and a Ga oxide are added to the raw material in small amounts, the reaction temperatures of the fluorination reaction and the solid-phase reaction can be decreased, for example, by about 10° C. to 20° C., and the reactivity of the fluorination reaction and the solid-phase reaction can be improved. Accordingly, the fluorination reaction and the solid-phase reaction of the raw material can be promoted. Two or more selected from the group consisting of the Ti oxide, the Si oxide, the Cu oxide, and the Ga oxide may be added together, or only one selected from the group consisting of the Ti oxide, the Si oxide, the Cu oxide, and the Ga oxide may be added. For example, when the Ti oxide, the Si oxide, the Cu oxide, and the Ga oxide are added for the purpose of promoting the fluorination reaction and the solid-phase reaction, the total of the addition amounts of the Ti oxide, the Si oxide, the Cu oxide, and the Ga oxide may be, for example, 0.001 mol % or more and 0.3 mol % or less with respect to the raw material.

The additives such as the Ti oxide, the Si oxide, the Cu oxide, and the Ga oxide may be, for example, in particle form. Depending on the particle form of each additive and the dispersion state of each additive with respect to the raw material, the action effect of the additive may vary. As for the Ti oxide, the Si oxide, the Cu oxide, and the Ga oxide, in general, the smaller the particle size is, the higher the obtained effects of the additives such as reaction-promoting effects are. For example, the particle diameter of each additive may be smaller than that of the particles of the raw material. As an example, the additive may be fine particles having a particle diameter of 0.1 μm or less and a BET specific surface area of 100 m²/g or more. When the Ti oxide, the Si oxide, the Cu oxide, and the Ga oxide are used as coarse particles or excessively added, undesired precipitate phases other than solid electrolytes may be generated and ionic conductivity may be reduced. Therefore, it is desirable to adjust the particle size and the addition amount to an appropriate size and amount. Ti, Si, Cu, and Ga derived from the Ti oxide, the Si oxide, the Cu oxide, and the Ga oxide added as the additives each act as an aid for conversion into the fluoride and solid-phase reaction and are taken into the solid electrolyte. For example, it is desirable that for the Ti oxide, the Si oxide, the Cu oxide, and the Ga oxide, the particle size and the addition amount should be set to a size and an amount with which Ti, Si, Cu, and Ga are not detected as composition phases in X-ray diffraction measurement of the finally obtained solid electrolyte. Accordingly, a solid electrolyte having high ionic conductivity can be synthesized while obtaining a reaction-promoting effect.

In the production method according to the second embodiment, in the case where at least one selected from the group consisting of the Ti oxide, the Si oxide, the Cu oxide, and the Ga oxide is used as an additive, the obtained solid electrolyte contains at least one selected from the group consisting of Ti, Si, Cu, and Ga. That is, in this case, the solid electrolyte obtained by the production method according to the second embodiment includes a first crystal phase represented by the composition formula (1): Li₃AlF₆ and having an orthorhombic crystal structure and further contains at least one selected from the group consisting of Ti, Si, Cu, and Ga. Owing to this configuration, a homogeneous solid electrolyte having excellent ionic conductivity is obtained.

The amount of oxygen as an impurity in the solid electrolyte obtained by the production method according to the second embodiment may be 0.5 mass % or less. With the production method according to the second embodiment, a solid electrolyte into which a small amount of oxygen is incorporated can be obtained. The amount of oxygen as an impurity in the solid electrolyte may be, for example, 0.1 mass % or more.

### Third Embodiment

Hereinafter, a production method for a solid electrolyte according to a third embodiment will be described.

The production method according to the third embodiment further includes, after the above (A) in the production method according to the second embodiment,
(B) performing pulverization treatment on the solid electrolyte obtained in the above (A).

In the production method according to the third embodiment, by performing the pulverization treatment in the above (B), a solid electrolyte having excellent ionic conductivity and reliability can be obtained with powder characteristics (e.g., particle shape, surface amorphization, etc.) suitable for the application. In addition, at least a part of the solid electrolyte can be amorphized, so that ionic conductivity can be improved and the softness of the particles of the solid electrolyte can be improved. By improving the softness of the particles of the solid electrolyte, the density of a compacted powder of the solid electrolyte can be improved. Therefore, with the solid electrolyte obtained by the production method according to the third embodiment, a dense compacted powder having high ionic conductivity can be formed.

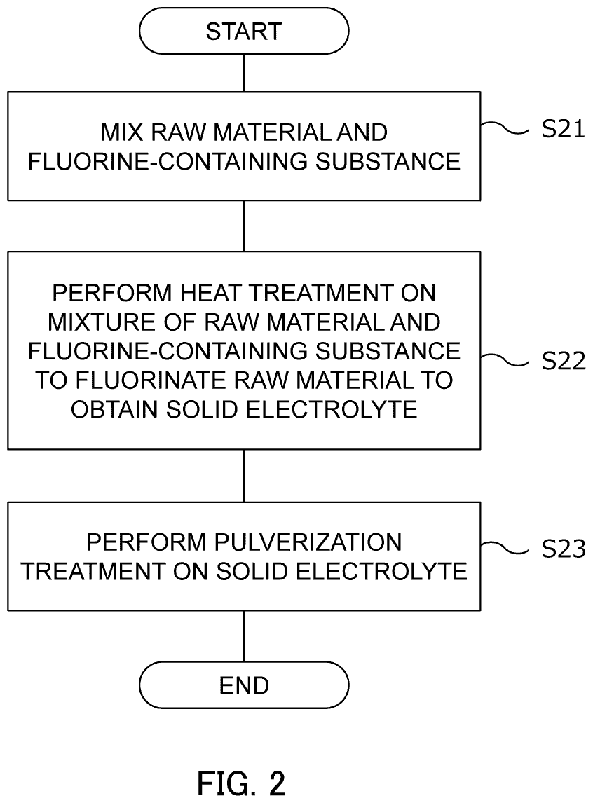

FIG. 2 is a flowchart showing an example of the production method for a solid electrolyte according to the third embodiment. Here, an example of a production method in which the above (B) is performed after the above (A-2) in the production method in which the above (A-1) and the above (A-2) are performed as the above (A) and which is an example of the production method described in the second embodiment, will be described.

As shown in FIG. 2, first, a raw material and a fluorine-containing substance are mixed (S21). Next, fluorination treatment is performed on the raw material by performing heat treatment on the obtained mixture including the raw material and the fluorine-containing substance (S22). Accordingly, a solid electrolyte including a first crystal phase represented by the composition formula (1): Li₃AlF₆ and having an orthorhombic crystal structure is obtained. Next, as a step corresponding to the above (B), pulverization treatment is performed on the solid electrolyte obtained in S22 (S23).

S21 and S22 are the same as S11 and S12 described in the second embodiment, respectively, and thus the detailed description thereof is omitted here.

The solid electrolyte pulverized in the above (B) includes, for example, fine particles having a BET specific surface area of 2.0 m²/g or more and 30 m²/g or less. Such a solid electrolyte has characteristics of excellent ionic conductivity and excellent stability in atmospheric air, is soft and therefore deformable, and can also be pulverized. Therefore, the solid electrolyte is useful for solid electrolyte layers, composite components of active material layers, and coating layers for active material particles. Thus, higher performance and higher reliability of a battery are achieved.

The pulverization treatment only has to be performed such that the fluoride can be pulverized into small pieces having the desired particle size and may be performed by a dry method or a wet method using water or a solvent (e.g., ethanol, butyl acetate, or the like). For example, zirconia balls (e.g., balls with a diameter of 1 mm to 30 mm) and the solid electrolyte obtained in the above (A) are placed in a ball mill container, and the solid electrolyte is pulverized for 4 to 80 hours, for example. As the ball mill container, for example, a container made of polyethylene, a container lined with a fluorine resin or zirconia, etc., can be used.

The pulverization treatment in the above (B) may include, for example, mechanochemical treatment. Here, the mechanochemical treatment is performed in order to introduce distorted crystals or amorphous properties to the crystals of the solid electrolyte. Distorted crystals or amorphous properties are mainly introduced into the surface layers of the particles of the solid electrolyte. The specific means for this may be the same as in the pulverization treatment described above, and, for example, a ball mill is used. However, the pulverization conditions may be strengthened or the time may be extended. A device, a medium, etc., used for the mechanochemical treatment may be the same as in the pulverization treatment, and in general, pulverization and the mechanochemical treatment proceed at the same time. As an example, in the case of a dry method, a container lined with zirconia is used, zirconia balls with a volume ratio of 10% to 60% are placed therein, and mechanochemical milling is performed along with pulverization. The diameter of the zirconia balls is not particularly limited and balls with any size can be used. Normally, as described above, commercially available balls with a diameter of 1 mm to 30 mm are used, but balls having a smaller diameter than these balls may be used, or balls having a larger diameter than these balls may be used. The diameter of the balls to be used may be selected as desired according to a target particle size or degree of amorphization. In addition, an appropriate amount of an additive that does not adversely affect the characteristics of the solid electrolyte, such as ethanol, may be added in order to suppress the adhesion of the solid electrolyte to the zirconia balls or the inner wall of the zirconia container. The additive is preferably an additive that can be dried and removed later.

The introduction of amorphous properties into the solid electrolyte can be confirmed by an X-ray diffraction pattern obtained by X-ray diffraction measurement. The X-ray diffraction pattern can be measured by the θ-2θ method using Cu-Kα rays (wavelengths: 1.5405 Å and 1.5444 Å) as X-ray sources. Specifically, this introduction can be confirmed by the fact that the peak of an X-ray diffraction pattern of the solid electrolyte after the pulverization treatment widens compared with the peak of an X-ray diffraction pattern of the solid electrolyte before the pulverization treatment is performed. The fact that the peak widens means that the peak is broad and the full width at half maximum widens.

The introduction of distorted crystals into the solid electrolyte, that is, the presence of disturbed crystalline regions, can be observed by a transmission electron microscope (TEM) as images of highly regular regions of a lattice image and disturbed regions of the lattice image.

In addition, changes in deformability due to amorphization can be evaluated by evaluation methods such as Micro-Vickers.

As described above, the production method according to the third embodiment includes the pulverization treatment, and thus the solid electrolyte obtained by the production method according to the second embodiment includes, for example, an amorphous phase. Owing to this configuration, the amorphized part of the solid electrolyte becomes even softer and has excellent deformability. Therefore, with a compacted powder of the solid electrolyte, a solid electrolyte layer having higher ionic conductivity and higher stability can be formed in any shape. Therefore, with the compacted powder of the solid electrolyte including the amorphous phase, a solid electrolyte layer of a battery having excellent characteristics and high reliability can be realized.

As a modification of the production method according to the third embodiment, when performing the pulverization treatment in the above (B), the solid electrolyte may be slurried, for coating film formation, simultaneously with the pulverization treatment.

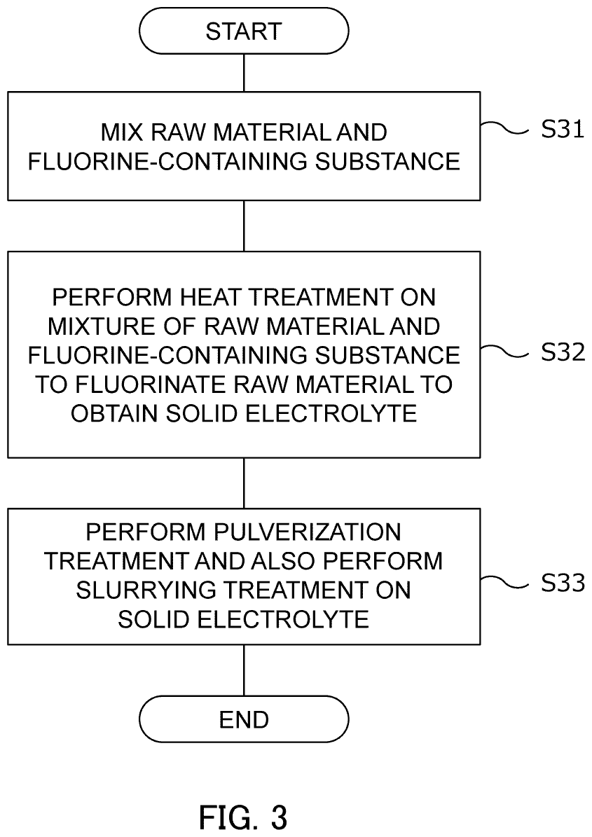

FIG. 3 is a flowchart showing a modification of the production method for a solid electrolyte according to the third embodiment. As for the modification of the production method according to the third embodiment as well, an example of a production method in which the above (B) is performed after the above (A-2) in the production method in which the above (A-1) and the above (A-2) are performed as the above (A) and which is an example of the production method described in the second embodiment, will be described here.

As shown in FIG. 3, first, a raw material and a fluorine-containing substance are mixed (S31). Next, fluorination treatment is performed on the raw material by performing heat treatment on the obtained mixture including the raw material and the fluorine-containing substance (S32). Accordingly, a solid electrolyte including a first crystal phase represented by the composition formula (1): Li₃AlF₆ and having an orthorhombic crystal structure is obtained. Next, as a step corresponding to the above (B), on the solid electrolyte obtained in S32, pulverization treatment is performed and slurrying treatment is also performed (S33).

S31 and S32 are the same as S11 and S12 described in the second embodiment, respectively, and thus the detailed description thereof is omitted here.

In S33, the pulverization treatment is the same as the pulverization treatment in S23 described as an example of the production method of the third embodiment. In the modification of the production method of the third embodiment, the slurrying treatment is further performed. The slurrying treatment is performed, for example, by, simultaneously with the pulverization treatment, adding an organic binder, a plasticizer, or the like to the solid electrolyte in a state of being dispersed and included in an organic solvent such as tetralin. An example of the organic binder is a styrene butadiene block copolymer (SBS), for example. Examples of the plasticizer include dibutyl phthalate (DBP) and butyl benzyl phthalate (BBP).

Using the obtained slurry of the solid electrolyte, printing or coating can be performed. The thickness of a coating film may be, for example, 10 μm or more and 100 μm or less, and thus, for example, the slurry of the pulverized solid electrolyte including the amorphous part can be directly applied. As described above, in the pulverization treatment, a slurry of the solid electrolyte may be prepared by adding the organic binder, the plasticizer, or the like, and a coating film may be formed using this slurry. Accordingly, a coating film of the solid electrolyte having excellent characteristics can be formed. Such a coating film can be used, for example, for the manufacture of coated-type cells.

### Fourth Embodiment

Hereinafter, a production method for a solid electrolyte according to a fourth embodiment will be described.

In the production method according to the fourth embodiment, fluorine gas is generated by performing heat treatment on the fluorine-containing substance in the above (A) described in the second embodiment, and the fluorine gas is brought into contact with the raw material, thereby performing fluorination treatment on the raw material. In the production method according to the fourth embodiment, the pulverization treatment in the above (B) described in the third embodiment may be performed after the above (A).

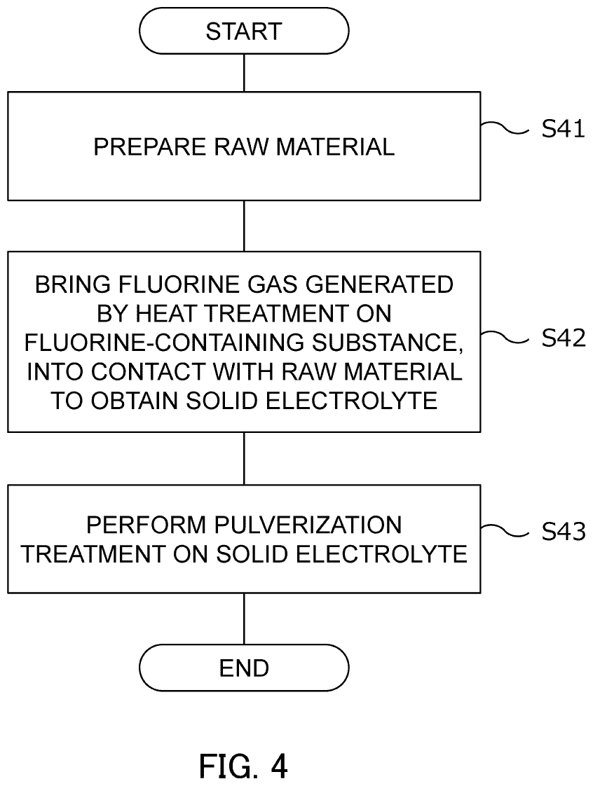

FIG. 4 is a flowchart showing an example of the production method for a solid electrolyte according to the fourth embodiment. As shown in FIG. 4, a raw material is prepared (S41). The raw material includes at least one selected from the group consisting of an oxide of Li, a carbonate of Li, and a hydroxide of Li and at least one selected from the group consisting of an oxide of Al, a carbonate of Al, and a hydroxide of Al, and is prepared by mixing them. An additive for promoting the fluorination reaction of the raw material, an additive for promoting the solid-phase reaction of the raw material, etc., are added to the raw material during the preparation of the raw material. That is, for example, at least one selected from the group consisting of a Ti oxide, an Si oxide, a Cu oxide, and a Ga oxide may be added to the raw material.

Next, the raw material and the fluorine-containing substance are placed at a predetermined position, heat treatment is performed on the fluorine-containing substance, and generated fluorine gas is brought into contact with the raw material (S42). Accordingly, fluorination treatment on the raw material is performed. Then, as a step corresponding to the above (B), pulverization treatment may be performed on the solid electrolyte obtained in S42 (S43).

In the production method according to the fourth embodiment, the raw material can be fluorinated by the generated fluorine gas without bringing the raw material into direct contact with the fluorine-containing substance. Therefore, even when a fluorine-containing substance containing an inorganic component in addition to a fluorine element (e.g., a substance that emits fluorine gas when heated, such as CuF2) is used, there is no need to consider inorganic residues being incorporated into the solid electrolyte to be produced. Therefore, the range of fluorine-containing substances that can be used can be expanded.

As a specific example, the raw material is placed, for example, on a nickel mesh with fine openings, and the fluorine-containing substance such as ammonium fluoride is placed under the nickel mesh. Thus, the raw material and the fluorine-containing substance are placed without contact with each other. In this state, by performing the heat treatment on the fluorine-containing substance, fluorine gas is generated, and this gas passes through the nickel mesh and comes into contact with the raw material. Accordingly, the raw material is converted into a fluoride. The raw material and the fluorine-containing substance are as described in the first embodiment. The heat treatment can be performed in atmospheric air, but heat treatment in a nitrogen atmosphere or reducing atmosphere is preferable in order to prevent the nickel mesh from oxidizing.

### Fifth Embodiment

Hereinafter, a production method for a solid electrolyte according to a fifth embodiment will be described.

The production method according to the fifth embodiment is a method in which Li₃AlF₆ having a monoclinic crystal structure is mixed into the solid electrolyte including a first crystal phase represented by the composition formula (1): Li₃AlF₆ and having an orthorhombic crystal structure, which is obtained by the production method of any one of the second embodiment to fourth embodiment, to obtain a solid electrolyte including both a first crystal phase and a second crystal phase.

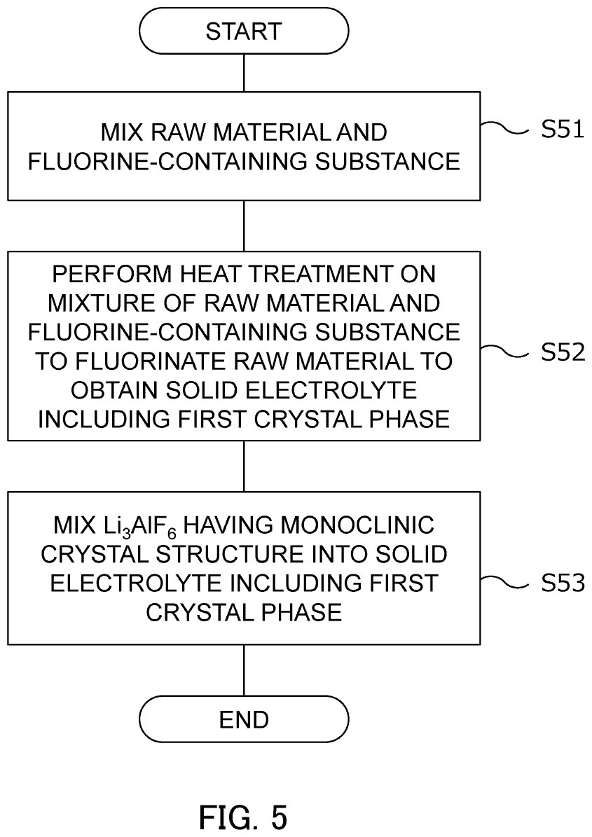

FIG. 5 is a flowchart showing an example of the production method for a solid electrolyte according to the fifth embodiment. Here, an example in which a solid electrolyte including a first crystal phase represented by the composition formula (1): Li₃AlF₆ and having an orthorhombic crystal structure is synthesized by the production method according to the second embodiment, will be described.

As shown in FIG. 5, a raw material and a fluorine-containing substance are mixed (S51). Next, fluorination treatment is performed on the raw material by performing heat treatment on the obtained mixture including the raw material and the fluorine-containing substance, to synthesize a solid electrolyte including a first crystal phase represented by the composition formula (1): Li₃AlF₆ and having an orthorhombic crystal structure (S52). Next, Li₃AlF₆ having a monoclinic crystal structure is mixed into the solid electrolyte including the first crystal phase (S53). Pulverization treatment may be performed on each of the solid electrolyte including the first crystal phase (i.e., Li₃AlF₆ having an orthorhombic crystal structure) and Li₃AlF₆ having a monoclinic crystal structure before the mixing in S53, or pulverization treatment may be performed on the mixture at the time of mixing in S53. As the pulverization treatment here, the pulverization treatment described in the production method according to the third embodiment can be performed.

Li₃AlF₆ having a monoclinic crystal structure may be synthesized, for example, by adjusting the heat treatment temperature during the fluorination treatment in each of the production methods of the second embodiment to fourth embodiment. That is, in each of the production methods of the second embodiment to fourth embodiment, a solid electrolyte in which the content ratio of Li₃AlF₆ having a monoclinic crystal structure (i.e., second crystal phase) is large may be synthesized by setting the heat treatment temperature during the fluorination treatment to a lower temperature, and the obtained solid electrolyte may be used as Li₃AlF₆ having a monoclinic crystal structure.

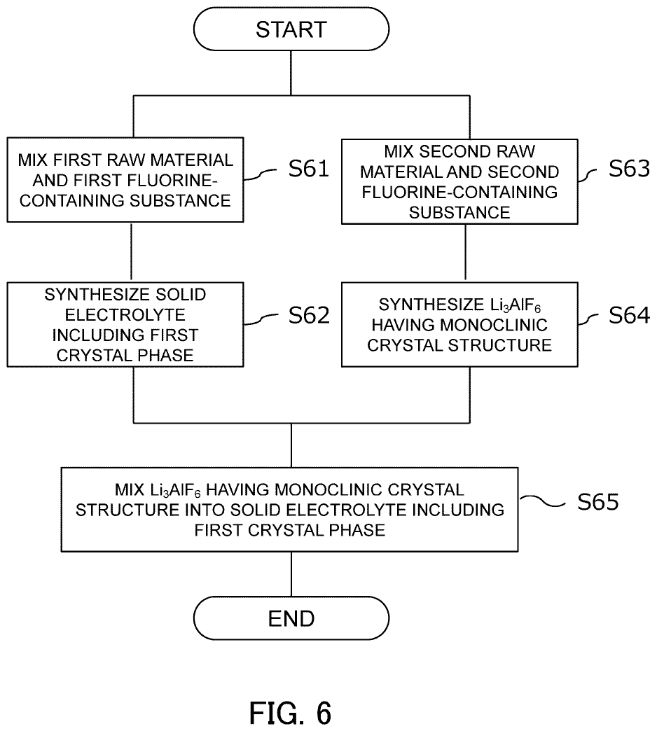

FIG. 6 is a flowchart showing a modification of the production method for a solid electrolyte according to the fifth embodiment. In this example, Li₃AlF₆ having a monoclinic crystal structure is synthesized using the production method according to the second embodiment. First, a first raw material and a first fluorine-containing substance are mixed (S61). The first raw material is a raw material for synthesizing a solid electrolyte including a first crystal phase and corresponds to the raw material described in the second embodiment. In addition, the first fluorine-containing substance corresponds to the fluorine-containing substance described in the second embodiment. Next, fluorination treatment is performed on the first raw material by performing heat treatment on the obtained first mixture including the first raw material and the first fluorine-containing substance, to synthesize a solid electrolyte including a first crystal phase represented by the composition formula (1): Li₃AlF₆ and having an orthorhombic crystal structure (S62). Meanwhile, a raw material including at least one selected from the group consisting of an oxide of Li, a carbonate of Li, and a hydroxide of Li and at least one selected from the group consisting of an oxide of Al, a carbonate of Al, and a hydroxide of Al, is prepared as a raw material (hereinafter referred to as second raw material) for Li₃AlF₆ having a monoclinic crystal structure. As the second raw material, the raw material described in the second embodiment can be used. The second raw material and a second fluorine-containing substance are mixed (S63). As the second fluorine-containing substance, the fluorine-containing substance described in the second embodiment can be used. Fluorination treatment is performed on the second raw material by performing heat treatment on the obtained second mixture including the second raw material and the second fluorine-containing substance, to synthesize a solid electrolyte in which the content ratio of Li₃AlF₆ having a monoclinic crystal structure (i.e., second crystal phase) is large, as Li₃AlF₆ having a monoclinic crystal structure (S64). Next, Li₃AlF₆ having a monoclinic crystal structure is mixed into the solid electrolyte including the first crystal phase (S65). Pulverization treatment may be performed on each of the solid electrolyte including the first crystal phase (i.e., Li₃AlF₆ having an orthorhombic crystal structure) and Li₃AlF₆ having a monoclinic crystal structure before the mixing in S65, or pulverization treatment may be performed on the mixture at the time of mixing in S65. As the pulverization treatment here, the pulverization treatment described in the production method according to the third embodiment can be performed.

With the above production method, a solid electrolyte including a first crystal phase represented by the composition formula (1): Li₃AlF₆ and having an orthorhombic crystal structure and a second crystal phase represented by the composition formula (1): Li₃AlF₆ and having a monoclinic crystal structure, can be produced by adjusting the content ratio of the first crystal phase and the second crystal phase. Accordingly, the ionic conductivity, the powder characteristics, and the processability can be adjusted individually, and thus the characteristics of the solid electrolyte can be widely adjusted.

Here, the method in which Li₃AlF₆ having an orthorhombic crystal structure and Li₃AlF₆ having a monoclinic crystal structure are mixed has been described as an example of the production method of the fifth embodiment. However, the production method of the fifth embodiment is not limited to this method, and two or more solid electrolytes having different content ratios of a first crystal phase having an orthorhombic crystal structure and a second crystal phase having a monoclinic crystal structure may be mixed. Moreover, instead of mixing solid electrolytes having different content ratios of a first crystal phase and a second crystal phase, multiple solid electrolytes having different production conditions such as different compositions or content amounts of a secondary component or different pulverized particle diameters may be combined and mixed.

### Sixth Embodiment

Hereinafter, a sixth embodiment will be described. The matters described in the first embodiment, the second embodiment, the third embodiment, the fourth embodiment, and the fifth embodiment are omitted as appropriate.

A battery according to the sixth embodiment includes a positive electrode, an electrolyte layer, and a negative electrode. The electrolyte layer is provided between the positive electrode and the negative electrode.

At least one selected from the group consisting of the positive electrode, the electrolyte layer, and the negative electrode includes the solid electrolyte according to the first embodiment, that is, a solid electrolyte including a first crystal phase represented by the composition formula (1): Li₃AlF₆ and having an orthorhombic crystal structure.

Owing to including the solid electrolyte according to the first embodiment, the battery according to the sixth embodiment has excellent charge and discharge characteristics.

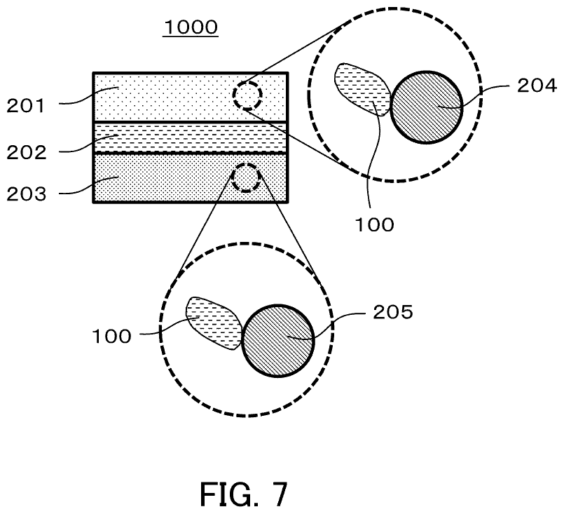

FIG. 7 illustrates a cross-sectional view of a battery 1000 according to the sixth embodiment.

The battery 1000 according to the sixth embodiment includes a positive electrode 201, an electrolyte layer 202, and a negative electrode 203. The electrolyte layer 202 is provided between the positive electrode 201 and the negative electrode 203.

The positive electrode 201 may include a positive electrode material including the solid electrolyte according to the first embodiment. The positive electrode 201 includes a positive electrode active material 204 and a solid electrolyte 100.

The electrolyte layer 202 includes an electrolyte material.

The negative electrode 203 includes a negative electrode active material 205 and the solid electrolyte 100.

The solid electrolyte 100 includes, for example, the solid electrolyte according to the first embodiment. The solid electrolyte 100 may be particles including the solid electrolyte according to the first embodiment as a main component. The particles including the solid electrolyte according to the first embodiment as a main component mean particles in which the component included in the largest amount in molar ratio is the solid electrolyte according to the first embodiment. The solid electrolyte 100 may be particles consisting of the solid electrolyte according to the first embodiment.

The positive electrode 201 includes a material capable of occluding and releasing metal ions (e.g., lithium ions). The material is, for example, the positive electrode active material 204.

Examples of the positive electrode active material 204 include a lithium-containing transition metal oxide, a transition metal fluoride, polyanion, a fluorinated polyanion material, a transition metal sulfide, a transition metal oxyfluoride, a transition metal oxysulfide, and a transition metal oxynitride. Examples of the lithium-containing transition metal oxide include Li(Ni, Co, Mn)O₂, Li(Ni, Co, Al)O₂, and LiCoO₂.

In the present disclosure, “(A, B, C)” means “at least one selected from the group consisting of A, B, and C”.

The shape of the positive electrode active material 204 is not limited to a specific shape. The positive electrode active material 204 may be particles. The positive electrode active material 204 may have a median diameter of 0.1 μm or more and 100 μm or less. In the case where the positive electrode active material 204 has a median diameter of 0.1 μm or more, the positive electrode active material 204 and the solid electrolyte 100 can be well dispersed in the positive electrode 201. Accordingly, the charge and discharge characteristics of the battery 1000 are improved. In the case where the positive electrode active material 204 has a median diameter of 100 μm or less, the diffusion rate of lithium in the positive electrode active material 204 improves. Accordingly, the battery 1000 can operate at a high power.

The positive electrode active material 204 may have a median diameter larger than that of the solid electrolyte 100. Accordingly, the positive electrode active material 204 and the solid electrolyte 100 can be well dispersed in the positive electrode 201.

In order to improve the energy density and power output of the battery 1000, the ratio of the volume of the positive electrode active material 204 to the total of the volume of the positive electrode active material 204 and the volume of the solid electrolyte 100 in the positive electrode 201 may be 0.30 or more and 0.95 or less.

A coating layer may be formed on at least a part of the surface of the positive electrode active material 204. The coating layer can be formed on the surface of the positive electrode active material 204, for example, before mixing a conductive additive and a binder. Examples of a coating material included in the coating layer include a sulfide solid electrolyte, an oxide solid electrolyte, and a halide solid electrolyte. In the case where the solid electrolyte 100 includes a sulfide solid electrolyte, the coating material may include the solid electrolyte according to the first embodiment to suppress oxidative decomposition of the sulfide solid electrolyte. In the case where the solid electrolyte 100 includes the solid electrolyte according to the first embodiment, the coating material may include an oxide solid electrolyte to suppress oxidative decomposition of the solid electrolyte. As the oxide solid electrolyte, lithium niobate having excellent high-potential stability may be used. By suppressing oxidative decomposition, an increase in overvoltage of the battery 1000 can be suppressed.

As described above, in the case where the positive electrode 201 includes a positive electrode material including the solid electrolyte according to the first embodiment, the positive electrode material may include the solid electrolyte according to the first embodiment as the solid electrolyte 100 or may include a coating material that coats the positive electrode active material 204.

In order to improve the energy density and power output of the battery 1000, the positive electrode 201 may have a thickness of 10 μm or more and 500 μm or less.

The electrolyte layer 202 includes an electrolyte material. The electrolyte material is, for example, a solid electrolyte. The solid electrolyte may include the solid electrolyte according to the first embodiment. The electrolyte layer 202 may be a solid electrolyte layer.

The electrolyte layer 202 may include 50 mass % or more of the solid electrolyte according to the first embodiment. The electrolyte layer 202 may include 70 mass % or more of the solid electrolyte according to the first embodiment. The electrolyte layer 202 may include 90 mass % or more of the solid electrolyte according to the first embodiment. The electrolyte layer 202 may consist only of the solid electrolyte according to the first embodiment.

Hereinafter, the solid electrolyte according to the first embodiment is referred to as first solid electrolyte. A solid electrolyte different from the first solid electrolyte is referred to as second solid electrolyte.

The electrolyte layer 202 may include not only the first solid electrolyte but also the second solid electrolyte. In the electrolyte layer 202, the first solid electrolyte and the second solid electrolyte may be uniformly dispersed. A layer consisting of the first solid electrolyte and a layer consisting of the second solid electrolyte may be stacked together along the stacking direction of the battery 1000.

The battery according to the sixth embodiment may include the positive electrode 201, a second electrolyte layer, a first electrolyte layer, and the negative electrode 203 in this order. Here, the solid electrolyte included in the first electrolyte layer may have a lower reduction potential than the solid electrolyte included in the second electrolyte layer. Accordingly, the solid electrolyte included in the second electrolyte layer can be used without being reduced. As a result, the charge and discharge efficiency of the battery 1000 can be improved. For example, in the case where the second electrolyte layer includes the first solid electrolyte, the first electrolyte layer may include a sulfide solid electrolyte to suppress reductive decomposition of the solid electrolyte. Accordingly, the charge and discharge efficiency of the battery 1000 can be improved. The second electrolyte layer may include the first solid electrolyte. The first solid electrolyte has high oxidation resistance, so that a battery having excellent charge and discharge characteristics can be realized.

The electrolyte layer 202 may consist only of the second solid electrolyte.

The electrolyte layer 202 may have a thickness of 1 μm or more and 1000 μm or less. In the case where the electrolyte layer 202 has a thickness of 1 μm or more, the positive electrode 201 and the negative electrode 203 are less likely to short circuit. In the case where the electrolyte layer 202 has a thickness of 1000 μm or less, the battery 1000 can operate at a high power.

Examples of the second solid electrolyte include Li₂MgX₄, Li₂FeX₄, Li(Al, Ga, In)X₄, Li₃(Al, Ga, In)X₆, and LiI, where X is at least one selected from the group consisting of F, Cl, Br, and I.

In order to improve the energy density and power output of the battery 1000, the electrolyte layer 202 may have a thickness of 1 μm or more and 1000 μm or less.

The negative electrode 203 includes a material capable of occluding and releasing metal ions (e.g., lithium ions). The material is, for example, the negative electrode active material 205.

Examples of the negative electrode active material 205 include a metal material, a carbon material, an oxide, a nitride, a tin compound, and a silicon compound. The metal material may be an elemental metal or an alloy. Examples of the metal material include lithium metal and a lithium alloy. Examples of the carbon material include a natural graphite, a coke, a semi-graphitized carbon, a carbon fiber, a spherical carbon, an artificial graphite, and an amorphous carbon. From the viewpoint of capacity density, preferred examples of the negative electrode active material include silicon (i.e., Si), tin (i.e., Sn), a silicon compound, and a tin compound.

The negative electrode active material 205 may be selected in consideration of the reduction resistance of the solid electrolyte material included in the negative electrode 203. For example, in the case where the negative electrode 203 includes the first solid electrolyte, the negative electrode active material 205 may be a material capable of occluding and releasing lithium ions at 0.27 V or more with respect to lithium. Examples of such a negative electrode active material include a titanium oxide, indium metal, and a lithium alloy. Examples of the titanium oxide include Li₄Ti₅O₁₂, LiTi₂O₄, and TiO₂. By using the above negative electrode active material, reductive decomposition of the first solid electrolyte included in the negative electrode 203 can be suppressed. As a result, the charge and discharge efficiency of the battery 1000 can be improved.

The shape of the negative electrode active material 205 is not limited to a specific shape. The negative electrode active material 205 may be particles. The negative electrode active material 205 may have a median diameter of 0.1 μm or more and 100 μm or less. In the case where the negative electrode active material 205 has a median diameter of 0.1 μm or more, the negative electrode active material 205 and the solid electrolyte 100 can be well dispersed in the negative electrode 203. Accordingly, the charge and discharge characteristics of the battery 1000 are improved. In the case where the negative electrode active material 205 has a median diameter of 100 μm or less, the diffusion rate of lithium in the negative electrode active material 205 improves. Accordingly, the battery 1000 can operate at a high power.

The negative electrode active material 205 may have a median diameter larger than that of the solid electrolyte 100. Accordingly, the negative electrode active material 205 and the solid electrolyte 100 can be well dispersed in the negative electrode 203.

In order to improve the energy density and power output of the battery 1000, the ratio of the volume of the negative electrode active material 205 to the total of the volume of the negative electrode active material 205 and the volume of the solid electrolyte 100 in the negative electrode 203 may be 0.30 or more and 0.95 or less.

In order to improve the energy density and power output of the battery 1000, the negative electrode 203 may have a thickness of 10 μm or more and 500 μm or less.

At least one selected from the group consisting of the positive electrode 201, the electrolyte layer 202, and the negative electrode 203 may include the second solid electrolyte for the purpose of increasing ionic conductivity, chemical stability, and electrochemical stability.

The second solid electrolyte may be a sulfide solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

In the case where the electrolyte layer 202 includes the first solid electrolyte, the negative electrode 203 may include a sulfide solid electrolyte to suppress reductive decomposition of the solid electrolyte. By covering the negative electrode active material with the sulfide solid electrolyte which is electrochemically stable, contact of the first solid electrolyte with the negative electrode active material can be suppressed. As a result, the internal resistance of the battery 1000 can be reduced.

The second solid electrolyte may be an oxide solid electrolyte.

Examples of the oxide solid electrolyte include:
(i) a NASICON solid electrolyte such as LiTi₂(PO₄)₃ and element-substituted substances thereof;
(ii) a perovskite solid electrolyte such as (LaLi)TiO₃;
(iii) a LISICON solid electrolyte such as Li₁₄ZnGe₄O₁₆, Li₄SiO₄, and LiGeO₄ and element-substituted substances thereof;
(iv) a garnet solid electrolyte such as Li₇La₃Zr₂O₁₂ and element-substituted substances thereof; and
(v) Li₃PO₄ and N-substituted substances thereof.

As described above, the second solid electrolyte may be a halide solid electrolyte.

Examples of the halide solid electrolyte include Li₂MgX₄, Li₂FeX₄, Li(Al, Ga, In)X₄, Li₃(Al, Ga, In)X₆, and LiI, where X is at least one selected from the group consisting of F, Cl, Br, and I.

Another example of the halide solid electrolyte is a compound represented by LiₐMe_{b}Y_{c}Z₆, where a+mb+3c=6 and c>0 are satisfied. Me is at least one selected from the group consisting of metal elements other than Li and Y and metalloid elements. Z is at least one selected from the group consisting of F, Cl, Br, and I. The symbol m represents the valence of Me. The “metalloid elements” are B, Si, Ge, As, Sb, and Te. The “metal elements” are: all the elements included in Groups 1 to 12 of the periodic table (excluding hydrogen); and all the elements included in Groups 13 to 16 of the periodic table (excluding B, Si, Ge, As, Sb, Te, C, N, P, O, S, and Se).

In order to improve the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The halide solid electrolyte may be Li₃YCl₆ or Li₃YBr₆.

The second solid electrolyte may be an organic polymer solid electrolyte.

An example of the organic polymer solid electrolyte is a compound of a polymer compound with a lithium salt.

The polymer compound may have an ethylene oxide structure. A polymer compound having an ethylene oxide structure can contain a large amount of a lithium salt, and accordingly can further increase the ionic conductivity.

Examples of the lithium salt include LiPF₆, LiBF₄, LiSbF₆, LiAsF₆, LiSO₃F₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from these may be used.

In order to facilitate transfer of lithium ions and thereby improve the output characteristics of the battery, at least one selected from the group consisting of the positive electrode 201, the electrolyte layer 202, and the negative electrode 203 may include a nonaqueous electrolyte solution, a gel electrolyte, or an ionic liquid.

The nonaqueous electrolyte solution contains a nonaqueous solvent and a lithium salt dissolved in the nonaqueous solvent.

Examples of the nonaqueous solvent include a cyclic carbonate solvent, a linear carbonate solvent, a cyclic ether solvent, a linear ether solvent, a cyclic ester solvent, a linear ester solvent, and a fluorinated solvent. Examples of the cyclic carbonate solvent include ethylene carbonate, propylene carbonate, and butylene carbonate. Examples of the linear carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the linear ether solvent include 1,2-dimethoxyethane and 1,2-diethoxyethane. Examples of the cyclic ester solvent include γ-butyrolactone. Examples of the linear ester solvent include methyl acetate. Examples of the fluorinated solvent include fluoroethylene carbonate, methyl fluoropropionate, fluorobenzene, fluoroethyl methyl carbonate, and fluorodimethylene carbonate. One nonaqueous solvent selected from these may be used alone. Alternatively, a combination of two or more nonaqueous solvents selected from these may be used.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from these may be used. The concentration of the lithium salt falls, for example, within a range from 0.5 mol/L to 2 mol/L.

As the gel electrolyte, a polymer material impregnated with a nonaqueous electrolyte solution can be used. Examples of the polymer material include polyethylene oxide, polyacrylonitrile, polyvinylidene fluoride, polymethyl methacrylate, and a polymer having an ethylene oxide bond.

Examples of cations contained in the ionic liquid include:
(i) aliphatic linear quaternary salts such as tetraalkylammoniums and tetraalkylphosphoniums;
(ii) aliphatic cyclic ammoniums such as pyrrolidiniums, morpholiniums, imidazoliniums, tetrahydropyrimidiniums, piperaziniums, and piperidiniums; and
(iii) nitrogen-containing heterocyclic aromatic cations such as pyridiniums and imidazoliums.

Examples of anions contained in the ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may contain a lithium salt.

In order to improve the adhesion between particles, at least one selected from the group consisting of the positive electrode 201, the electrolyte layer 202, and the negative electrode 203 may contain a binder.

Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. A copolymer can also be used as the binder. Examples of such a binder include a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from these may be used as the binder.

At least one of the positive electrode 201 and the negative electrode 203 may contain a conductive additive in order to improve electronic conductivity.

Examples of the conductive additive include:
(i) graphites such as a natural graphite and an artificial graphite;
(ii) carbon blacks such as acetylene black and ketjen black;
(iii) conductive fibers such as a carbon fiber and metal fiber;
(iv) fluorinated carbon;
(v) metal powders such as an aluminum powder;
(vi) conductive whiskers such as a zinc oxide whisker and a potassium titanate whisker;
(vii) a conductive metal oxide such as titanium oxide; and
(viii) a conductive polymer compound such as polyaniline compound, polypyrrole compound, and polythiophene compound. To reduce the cost, the conductive additive in (i) or (ii) above may be used.

Instead of the electrolyte layer, a separator impregnated with an electrolyte solution may be used, or a casing in which a positive electrode, a separator portion, and a negative electrode are housed may be filled with an electrolyte solution. The electrolyte solution may be, for example, the nonaqueous electrolyte solution described above. Examples of the shape of the battery according to the sixth embodiment include a coin type, a cylindrical type, a prismatic type, a sheet type, a button type, a flat type, and a stack type.

The battery according to the sixth embodiment may be manufactured, for example, by preparing a material for forming a positive electrode, a material for forming an electrolyte layer, and a material for forming a negative electrode, and producing by a known method a stack in which the positive electrode, the electrolyte layer, and the negative electrode are disposed in this order.

### Other Embodiments

### Additional Notes

The following techniques are disclosed by the description of the above embodiments.

### (Technique 1)

A solid electrolyte including a first crystal phase represented by the following composition formula (1) and having an orthorhombic crystal structure,

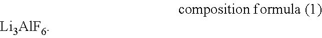

The solid electrolyte having the above configuration is a novel solid electrolyte that is highly useful. For example, the solid electrolyte having the above configuration can have characteristics of high ionic conductivity and excellent stability. For example, the solid electrolyte having the above configuration can be synthesized, for example, at a low temperature (e.g., about 150° C. or higher and 700° C. or lower) and thus is less likely to be exposed to a high temperature for a long time during production. Accordingly, during production, the solid electrolyte does not become hard due to excessive sintering, or the particle growth of the solid electrolyte does not excessively proceed. Therefore, the solid electrolyte having the above configuration is, for example, soft and excellent in deformability, and further can be provided as fine particles. When such a solid electrolyte having excellent deformability as fine particles is made into a compacted powder, an interface where particles are in close contact with each other is easily formed. To explain in more detail, the contact between particles that are difficult to deform becomes a point contact, while the contact between particles that are easy to deform forms a surface (joint interface) since the contact point between the particles spreads. Accordingly, voids are reduced and densification is achieved. Therefore, the solid electrolyte having the above configuration can be highly densified and is easily thinned, and further improvement of the ionic conductivity thereof can also be expected. Therefore, the solid electrolyte according to Technique 1 is a highly useful solid electrolyte that, when used, for example, for a solid electrolyte layer of a battery, can achieve thinning of the solid electrolyte layer or can be suitably used for a coating layer for active material particles. Therefore, with the solid electrolyte according to Technique 1, a battery having high performance is realized.

### (Technique 2)

The solid electrolyte according to Technique 1, wherein
the solid electrolyte includes a particle having a particle diameter of 1 μm or less.

In the case where the solid electrolyte having the above configuration is used, for example, for a solid electrolyte layer of a battery, further thinning of the solid electrolyte layer can be achieved, or the solid electrolyte can be more suitably used for a coating layer for active material particles. Therefore, with the solid electrolyte of Technique 2, a battery having higher performance is realized.

### (Technique 3)

The solid electrolyte according to Technique 2, wherein
an average particle diameter of the solid electrolyte is 1 μm or less.

In the case where the solid electrolyte having the above configuration is used, for example, for a solid electrolyte layer of a battery, further thinning of the solid electrolyte layer can be achieved, or the solid electrolyte can be more suitably used for a coating layer for active material particles. Therefore, with the solid electrolyte of Technique 3, a battery having higher performance is realized.

### (Technique 4)

The solid electrolyte according to any one of Techniques 1 to 3, wherein
the solid electrolyte includes a particle having a particle diameter of 0.3 μm or more.

Owing to the above configuration, the solid electrolyte including the first crystal phase having an orthorhombic crystal structure can have improved ionic conductivity.

### (Technique 5)

The solid electrolyte according to any one of Techniques 1 to 4, wherein
the solid electrolyte includes a particle having an aspect ratio of 2.0 or more.

Owing to the above configuration, the solid electrolyte including the first crystal phase having an orthorhombic crystal structure can have improved ionic conductivity. In addition, in the case where printing or coating is performed with a slurry containing the solid electrolyte according to Technique 5, the particles of the solid electrolyte are easily oriented and arranged along the printing or coating surface. Therefore, in the case where the solid electrolyte according to Technique 5 is used for a solid electrolyte layer of a battery, further thinning of the solid electrolyte layer can be achieved, and densification of the solid electrolyte layer can also be achieved. Accordingly, the resistance of the solid electrolyte layer can be reduced. With the solid electrolyte according to Technique 5, a small-sized battery having a high capacity density can be realized. In addition, in the case where the solid electrolyte according to Technique 5 is used for a solid electrolyte layer of a battery, the resistance component of the solid electrolyte layer is reduced, so that a battery having high performance can be obtained.

### (Technique 6)

The solid electrolyte according to any one of Techniques 1 to 5, wherein
the solid electrolyte includes a particle having a free surface.

Owing to the above configuration, for example, a solid electrolyte having excellent stability in atmospheric air can be realized.

### (Technique 7)

The solid electrolyte according to any one of Techniques 1 to 6, wherein
the solid electrolyte further includes a second crystal phase represented by the composition formula (1) and having a monoclinic crystal structure.

Owing to the above configuration, a softer solid electrolyte having more excellent deformability can be obtained. As described above, when the softer solid electrolyte having more excellent deformability is made into a compacted powder, an interface where particles are in close contact with each other is easily formed, the solid electrolyte can be highly densified and is easily thinned, and further improvement of the ionic conductivity thereof can also be expected. Therefore, in the case where the solid electrolyte of Technique 7 is used for a battery, a battery having higher performance and excellent reliability can be realized.

### (Technique 8)

The solid electrolyte according to Technique 7, wherein
the solid electrolyte includes
   a first particle including the first crystal phase and not including the second crystal phase, and
   a second particle including the second crystal phase, and the second particle is softer than the first particle.

Owing to the above configuration, a softer solid electrolyte having more excellent deformability can be obtained. As described above, when the softer solid electrolyte having more excellent deformability is made into a compacted powder, an interface where particles are in close contact with each other is easily formed, the solid electrolyte can be highly densified and is easily thinned, and further improvement of the ionic conductivity thereof can also be expected. Furthermore, heat shock resistance during a thermal cycle, etc., is also improved. Therefore, in the case where the solid electrolyte of Technique 8 is used for a battery, a battery having higher performance and excellent reliability can be realized.

### (Technique 9)

The solid electrolyte according to any one of Techniques 1 to 8, wherein
the solid electrolyte further includes an amorphous phase.

Owing to the above configuration, the amorphized part of the solid electrolyte becomes softer, has more excellent deformability, and has improved interparticle bonding. Therefore, with a compacted powder of the solid electrolyte, a solid electrolyte layer having higher ionic conductivity and higher stability can be formed in any shape. Thus, with the compacted powder of the solid electrolyte of Technique 9, a solid electrolyte layer of a battery or a coating layer for active material particles which has excellent characteristics and high reliability can be realized. As a result, with the solid electrolyte of Technique 9, a battery having high performance and high reliability is realized.

### (Technique 10)

The solid electrolyte according to any one of Techniques 1 to 9, wherein
the solid electrolyte further includes at least one selected from the group consisting of Ti, Si, Cu, and Ga, as a secondary component.

Owing to the above configuration, a homogeneous solid electrolyte having excellent ionic conductivity is obtained.

### (Technique 11)

A production method for the solid electrolyte according to any one of Techniques 1 to 10, including

(A) mixing a raw material including at least one selected from the group consisting of an oxide of Li, a carbonate of Li, and a hydroxide of Li and at least one selected from the group consisting of an oxide of Al, a carbonate of Al, and a hydroxide of Al, and performing fluorination treatment on the mixed raw material.

The above production method uses relatively stable oxides, carbonates, and hydroxides as the raw material and causes fluorination of the raw material and a solid-phase reaction to occur simultaneously, so that a solid electrolyte including a first crystal phase represented by the composition formula (1): Li₃AlF₆ and having an orthorhombic crystal structure can be synthesized. In addition, with this production method, a solid electrolyte including a first crystal phase represented by the composition formula (1): Li₃AlF₆ and having an orthorhombic crystal structure can be synthesized at a low temperature (e.g., a temperature of about 150° C. or higher and 700° C. or lower) at which synthesis is impossible in a solid-phase reaction using a fluoride raw material. In addition, with this production method, a solid electrolyte having a desired composition can be accurately produced by controlling the ratio of each component of the raw material. Therefore, a solid electrolyte including a crystal phase represented by the composition formula (1): Li₃AlF₆ and having an orthorhombic crystal structure is easily produced stably at a low cost and can be produced with good reproducibility.

### (Technique 12)

The production method for the solid electrolyte according to Technique 11, wherein
in the (A), the fluorination treatment on the raw material is performed by performing heat treatment on a fluorine-containing substance having thermal decomposition properties.

With the above production method, fluorination of the raw material and a solid-phase reaction can be caused to occur simultaneously, and a solid electrolyte including a first crystal phase represented by the composition formula (1): Li₃AlF₆ and having an orthorhombic crystal structure can be synthesized. Therefore, a homogeneous solid electrolyte having excellent characteristics can be obtained in a short time while reducing reaction residues such as oxides. Furthermore, the temperatures of the fluorination reaction and the solid-phase reaction of the raw material and the reaction rates of these reactions can be controlled by selection of fluorine-containing substances having different thermal decomposition temperatures, adjustment of the particle diameter of the raw material, etc. Thus, fluorination treatment suitable for various raw materials can be performed.

### (Technique 13)

The production method for the solid electrolyte according to Technique 12, wherein
the fluorine-containing substance is in particle form.

With the above production method, the fluorine-containing substance easily becomes thermally decomposed, and the contact area between the raw material and the fluorine-containing substance is increased. Thus, with the above production method, the raw material can be efficiently fluorinated, and the fluorine-containing substance is less likely to remain in the finally obtained solid electrolyte. In addition, the fluorination reaction can be controlled by the particle shape of the fluorine-containing substance. For example, by making the particles of the fluorine-containing substance smaller, the temperature of the fluorination can be decreased, or the rate of the fluorination can be increased. In addition, by mixing the raw material and the fluorine-containing substance, uniform fluorination of the entire powder is enabled. Moreover, precise control of the fluorine amount is enabled. Thus, the synthesis of the desired solid electrolyte is enabled. In addition, the fluorine-containing substance can be used in an amount required for the fluorination of the raw material, so that, unlike the case where fluorine gas is introduced and used in a furnace, excess fluorine gas emission can be suppressed. Therefore, the environmental impact is reduced and the influence on corrosion of a furnace material, etc., is also reduced.

### (Technique 14)

The production method for the solid electrolyte according to Technique 12 or 13, wherein
the (A) includes
   (A-1) mixing the raw material and the fluorine-containing substance, and
   (A-2) fluorinating the raw material by performing heat treatment on a mixture including the raw material and the fluorine-containing substance obtained in the (A-1), to obtain the solid electrolyte.

In the above production method, the heat treatment for the fluorination treatment can be performed on a homogeneous mixture obtained by mixing the raw material and the fluorine-containing substance. In addition, the contact area between the raw material and the fluorine-containing substance can be increased. Therefore, in the above production method, the fluorination of the raw material can be uniformly promoted. Thus, a homogeneous solid electrolyte having excellent characteristics can be obtained with high productivity.

### (Technique 15)

The production method for the solid electrolyte according to any one of Techniques 12 to 14, wherein
in the (A), fluorine gas is generated by performing heat treatment on the fluorine-containing substance, and the raw material is fluorinated by bringing the fluorine gas into contact with the raw material, to obtain the solid electrolyte.

In the above production method, the raw material can be fluorinated by the generated fluorine gas without bringing the raw material into direct contact with the fluorine-containing substance. Therefore, even when a fluorine-containing substance containing an inorganic component in addition to a fluorine element is used, there is no need to consider inorganic residues being incorporated into the solid electrolyte to be produced. Therefore, the range of fluorine-containing substances that can be used can be expanded.

### (Technique 16)

The production method for the solid electrolyte according to any one of Techniques 12 to 15, wherein
the fluorine-containing substance includes ammonium fluoride.

The thermal decomposition of ammonium fluoride starts at a relatively low temperature (e.g., about 150° C.). Therefore, the ammonium fluoride salt is less likely to remain as an unnecessary inorganic component in the finally obtained solid electrolyte and can be thermally decomposed at a low temperature to fluorinate the raw material. Thus, in the above production method, the fluorine-containing substance is effective for fluorinating the raw material at a low temperature (e.g., about 150 to 200° C.). Accordingly, in the above production method, the solid electrolyte to be produced can be inhibited from being sintered and becoming hard, or the particle growth of the solid electrolyte can be inhibited from excessively proceeding. Therefore, a solid electrolyte that is softer, has more excellent deformability, and is in fine particle form, is obtained. Accordingly, the solid electrolyte obtained by the above production method easily achieves densification and thinning of a compacted powder thereof. For example, when the solid electrolyte obtained by the above production method is used for a solid electrolyte layer of a battery, further thinning and higher ionic conductivity of the solid electrolyte layer can be achieved, or the solid electrolyte can be suitably used for a coating layer for active material particles to achieve higher ionic conductivity of an electrode. Therefore, with the solid electrolyte produced by the above production method, a battery having higher performance is realized. Unnecessary inorganic components derived from the fluorine-containing substance can be inhibited from remaining in the finally obtained solid electrolyte. Furthermore, the energy for synthesis is saved, and the heating and cooling times are reduced, so that the productivity is also improved. Moreover, since synthesis at a low temperature is possible, the durability of the furnace material is improved, and the running cost and replacement frequency of a synthetic member are also significantly reduced.

### (Technique 17)

The production method for the solid electrolyte according to any one of Techniques 12 to 16, wherein
the fluorine-containing substance includes a resin.

With the above production method, the fluorine-containing substance can fluorinate the raw material while being thermally decomposed at a relatively high temperature (e.g., about 400° C. or higher and 600° C. or lower). Therefore, the above production method is suitable for the case where it is desired to carry out the fluorination of the raw material and the solid-phase reaction at a relatively high temperature (e.g., about 400° C. or higher and 600° C. or lower).

### (Technique 18)

The production method for the solid electrolyte according to Technique 17, wherein
the resin is a fluorine resin.

The fluorine resin such as PTFE and PVDF can fluorinate the raw material while being thermally decomposed at a relatively high temperature (e.g., about 400° C. or higher and 600° C. or lower). Therefore, the production method of Technique 18 is suitable for the case where it is desired to carry out the fluorination of the raw material and the solid-phase reaction at a relatively high temperature (e.g., about 400° C. or higher and 600° C. or lower).

### (Technique 19)

The production method for the solid electrolyte according to any one of Techniques 12 to 18, wherein
the fluorine-containing substance includes a substance from which inorganic components generated by thermal decomposition during the heat treatment in the (A), other than a fluorine element, are substantially not incorporated into the solid electrolyte.

For the fluorine-containing substance, it is required that while the fluorine element generated by thermal decomposition during the heat treatment in the above (A) is replacing the oxygen element of the raw material, the other components are not incorporated as inorganic residues into the finally obtained solid electrolyte including a first crystal phase represented by the composition formula (1): Li₃AlF₆ and having an orthorhombic crystal structure. By using, as the fluorine-containing substance, a substance from which the inorganic components generated by thermal decomposition during the heat treatment, other than the fluorine element, are substantially not incorporated into the finally obtained solid electrolyte, only the fluorine element replaces oxygen, and the incorporation of inorganic residues into the solid electrolyte can be suppressed. As a result, a high-purity solid electrolyte having a desired composition can be obtained. Examples of the fluorine-containing substance from which the inorganic components generated by thermal decomposition during the heat treatment, other than the fluorine element, are substantially not incorporated into the finally obtained solid electrolyte, include substances from which inorganic components generated by thermal decomposition during heat treatment, other than the fluorine element, are converted into gas and discharged.

### (Technique 20)

The production method for the solid electrolyte according to any one of Techniques 12 to 19, wherein
the fluorine-containing substance includes a plurality of types of fluorine-containing compounds.

In the above production method, for example, both ammonium fluoride and the fluorine resin can be used as the fluorine-containing substance. Accordingly, the temperature range where the fluorine-containing substance acts as a fluorine source can be controlled to be wide. Thus, the conversion of the raw material into the fluoride and the solid-phase reaction temperature can be controlled over a wide range. Therefore, with the above production method, it becomes easy to synthesize the desired solid electrolyte.

### (Technique 21)

The production method for the solid electrolyte according to any one of Techniques 11 to 20, further including
(B) performing pulverization treatment on the solid electrolyte obtained in the (A), after the (A).

With the above production method, a solid electrolyte can be obtained with powder characteristics (e.g., particle shape, surface amorphization, etc.) suitable for the application. With the above production method, at least a part of the solid electrolyte can be amorphized, so that ionic conductivity can be improved and the softness of the particles of the solid electrolyte can be improved. By improving the softness of the particles of the solid electrolyte, the density of a compacted powder of the solid electrolyte can be improved. Therefore, with the solid electrolyte obtained by the production method according to Technique 21, a dense compacted powder having high ionic conductivity can be formed.

### (Technique 22)

A positive electrode material including the solid electrolyte according to any one of Techniques 1 to 10.

With the positive electrode material according to Technique 22, a battery having high performance such as excellent charge and discharge characteristics can be realized.

### (Technique 23)

A battery including a positive electrode including the positive electrode material according to Technique 22.

Owing to this configuration, a battery having high performance such as excellent charge and discharge characteristics can be provided.

### (Technique 24)

A battery including:
a positive electrode;
a negative electrode; and
an electrolyte layer provided between the positive electrode and the negative electrode, wherein
at least one selected from the group consisting of the positive electrode, the negative electrode, and the electrolyte layer includes the solid electrolyte according to any one of Techniques 1 to 10.
   Owing to this configuration, a battery having high performance such as excellent charge and discharge characteristics can be provided.

Although the solid electrolyte and the production method therefor according to the present disclosure have been described above based on the embodiments, the present disclosure is not limited to these embodiments. The embodiments including various modifications conceived of by a person skilled in the art, and other embodiments configured by combining some of components of the embodiments are also included in the scope of the present disclosure as long as the embodiments do not depart from the gist of the present disclosure.

In the above-described embodiments, various changes, replacements, additions, omissions, or the like can be made within the scope of the claims or the scope equivalent thereto.

### EXAMPLES

Hereinafter, the present disclosure will be described in more detail with reference to an example.

### Synthesis of Solid Electrolyte

### Example 1

Li₂CO₃ (average particle diameter: about 1.5 μm) and Al₂O₃ (average particle diameter: 0.3 μm) as raw materials, NH₄F (average particle diameter: about 120 μm) as a fluorine-containing substance, and TiO₂ (average particle diameter: about 0.5 μm, rutile type), SiO₂ (average particle diameter: about 0.3 μm), CuO (average particle diameter: about 1.2 μm), and Ga₂O₃ (average particle diameter: about 0.8 μm) as additives were prepared.

Li₂CO₃ and Al₂O₃ were weighed such that Li₃AlO₃ was synthesized. In addition, as for the additives, each powder was weighed such that TiO₂ was 0.01 mol %, SiO₂ was 0.005 mol %, CuO was 0.001 mol %, and Ga₂O₃ was 0.005 mol %, with respect to Li₃AlO₃ to be synthesized. The weighing of these raw materials and additives was performed in an air atmosphere.

The powders of the raw materials and additives weighed as described above were mixed. 30 g of the obtained mixture powder, 600 g of φ5 mm zirconia balls, and 200 mL of ethanol were placed in a ball mill having a capacity of 600 mL, and the mixture was mixed and pulverized for 20 h to prepare a slurry. The obtained slurry was dried at atmospheric pressure for 20 h using a hot air dryer at about 50 to 60° C. The dried powder was ground using a mortar and a pestle for about 10 minutes and then passed through a #32 mesh sieve to obtain a raw material powder including the raw materials and additives. The average particle diameter of the obtained raw material powder was about 0.46 μm.

Subsequently, NH₄F powder, which is a fluorine-containing substance, and the raw material powder were mixed. The NH₄F powder was added in an amount required for fluorination of the raw materials. Specifically, an amount of NH₄F that fluorinates all raw materials in the reaction formula was used.

The mixture of the raw material powder and the NH₄F powder was mixed with a pestle for about 10 minutes using an alumina mortar such that the mixture was uniform (step corresponding to the above (A-1)). Accordingly, a mixture including the raw materials, the additives, and the fluorine-containing substance was obtained. The mixing of these materials was performed in normal atmospheric air as at the time of weighing.

Next, heat treatment was performed on the obtained mixture (step corresponding to the above (A-2)). As a sagger, a high-purity (SSA-H) alumina crucible (diameter φ: 36 mm, height: 40 mm) was used, and about 3 g of the mixture was placed in the crucible. A spacer (thickness: 0.5 mm) was placed at the outer edge of the upper surface of the sagger in order to provide a gap such that reactive gas (mainly ammonia and CO₂) to be discharged during the heat treatment was allowed to easily escape, and an alumina plate-like lid was placed thereon to prevent foreign objects from falling. Next, the sagger having the lid placed as described above was placed at a center portion of a firing furnace, and heat treatment was performed. In the firing furnace, the sagger was placed on a support made of mullite and having a porosity of about 20% and a small heat capacity. A support having a length of 10 mm, a width of 10 mm, and a height of 10 mm was used, and three supports were placed under one sagger to float the sagger from the bottom of the furnace. Thus, heater (radiation) heat and an inert gas were allowed to circulate around to the bottom of the sagger. After the door of the furnace was closed and sealed, as the inert gas, nitrogen gas was caused to flow in at 2 L/min through an introduction port in the bottom of the furnace and was discharged through an exhaust port on the upper side of a ceiling, and the gas was continuously caused to flow until the heat treatment was completed. The temperature of the heat treatment was 320° C.

A solid electrolyte of this example was synthesized by using the carbonates and the oxides as a raw material, and performing fluorination treatment on a mixture thereof to fluorinate each component constituting the raw material and perform a solid-phase reaction. In the production method of this example, no evaporable components are generated, so that the need for reactions in a sealed container was eliminated, and heat treatment (firing) could be performed in a manner similar to that of general oxide ceramics, without causing compositional variations.

On the solid electrolyte obtained by the above heat treatment, pulverization treatment was performed (step corresponding to the above (B)). In this example, dry pulverization treatment was performed. Specifically, zirconia balls (diameter: 15 mm) and the solid electrolyte obtained by the above heat treatment were placed in a ball mill (volume: 1 L) lined with zirconia, and the solid electrolyte was pulverized for 36 h.

### Comparative Example 1

Fluorides were used as raw materials, and a solid electrolyte of Comparative Example 1 was produced by mechanochemical synthesis. Specifically, LiF and AlF₃ were prepared to have a molar ratio of LiF:AlF₃=3:1. In an Ar atmosphere (glove box), these materials were ground and mixed in a mortar for about 5 minutes. 10 g of the obtained mixture was placed in a planetary ball mill having a capacity of 500 mL together with 400 g of φ5 mm zirconia balls, the planetary ball mill was sealed, and mechanochemical milling was performed at 500 rpm for 20 h. Thus, the solid electrolyte of Comparative Example 1 was synthesized.

### <Evaluation of Solid Electrolyte>

The crystal phase, the ionic conductivity, the electronic conductivity, the average particle diameter, and the BET specific surface area of the solid electrolyte of Example 1 synthesized as described above were evaluated, and further, the particle shape thereof was also observed by an SEM. The crystal phase, the ionic conductivity, the average particle diameter, and the BET specific surface area were evaluated for both solid electrolytes after the heat treatment and before the pulverization treatment and after the pulverization treatment. In addition, the solid electrolyte of Comparative Example 1 was also evaluated for crystal phase. Moreover, analysis of trace components was also performed for the solid electrolyte of Example 1.

### (Crystal Phase)

The crystal phase was confirmed by powder X-ray diffraction measurement both after the heat treatment and before the pulverization treatment and after the pulverization treatment. An X-ray diffractometer (MiniFlex600, manufactured by Rigaku) was used for measurement. Cu-Kα rays (wavelengths: 1.5405 Å and 1.5444 Å) were used as X-ray sources.

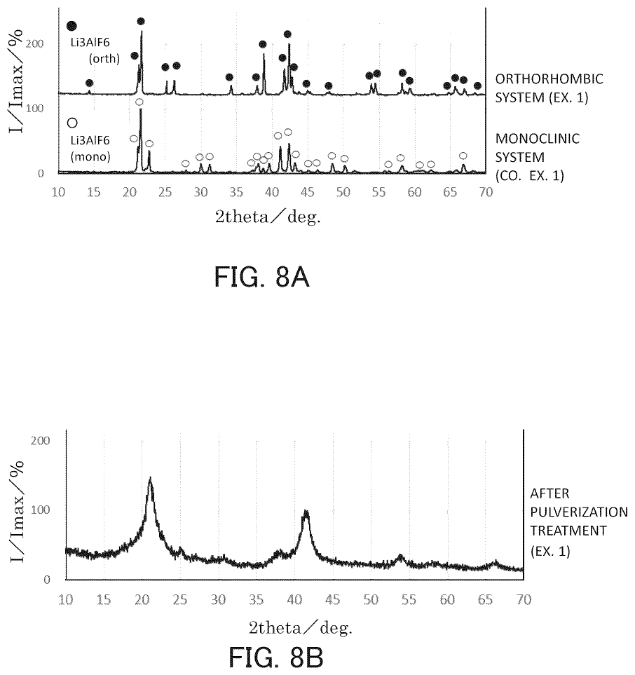

FIG. 8A is a graph showing an X-ray diffraction pattern of the solid electrolyte after the heat treatment and before the pulverization treatment in the production method of Example 1 and an X-ray diffraction pattern of the solid electrolyte obtained in Comparative Example 1. FIG. 8B is a graph showing an X-ray diffraction pattern of the solid electrolyte after the pulverization treatment obtained in Example 1. As shown in FIG. 8A, for the solid electrolyte after fluorination obtained in Example 1, an XRD pattern of Li₃AlF₆ having an orthorhombic crystal structure was confirmed. From the XRD pattern of the solid electrolyte after fluorination obtained in Example 1, only the orthorhombic crystal phase (first crystal phase) of Li₃AlF₆ was confirmed, and no other precipitate phases such as one with a composition related to the additive were detected. For the solid electrolyte obtained by further pulverizing the solid electrolyte after fluorination, the state of progress of amorphization was confirmed from the X-ray diffraction pattern shown in FIG. 8B. For the solid electrolyte after pulverization, compared with the solid electrolyte before the pulverization treatment, the crystallinity was reduced by the pulverization treatment, but no undesired precipitate phase was observed. The solid electrolyte obtained in Comparative Example 1 was Li₃AlF₆ having a monoclinic crystal structure.

### (Ionic Conductivity)

For the ionic conductivity, a powder of the solid electrolyte was placed in a mold having a diameter of 10 mm, and a compacted powder sample was obtained by applying a pressure of about 3 t/cm using a single-axis hydraulic press. The ionic conductivity was calculated from the area, the thickness, and the impedance characteristics at room temperature of the compacted powder sample. The impedance measurement was performed at room temperature with pressure applied. The impedance measurement was performed at a measurement frequency of 10 Hz to 10 MHz, a measurement voltage of 1 Vrms, and no DC bias. The deviation between the electrical lengths of a cable and a measurement jig was offset upon evaluation. For the solid electrolyte of Example 1, the ionic conductivity before the pulverization treatment was 0.93 μS/cm, and the ionic conductivity after the pulverization treatment was 3.8 μS/cm. For the solid electrolyte obtained in Comparative Example 1, the ionic conductivity after the pulverization treatment was 1.2 μS/cm.

### (Electronic Conductivity)

The electronic conductivity was calculated from a DC voltage and current characteristics. The electronic conductivity of the solid electrolyte of Example 1 was <1.0×10⁻⁹ μS/cm and was a value that could be determined to have no electron-conducting properties.

### (Average Particle Diameter)

The average particle diameter is the value of a median diameter D50 obtained from a volume particle size distribution measured by a laser diffraction scattering particle size distribution measuring device. Specifically, a powder of the solid electrolyte was dispersed in an aqueous solution of 0.01 wt % sodium hexametaphosphate with a homogenizer, and then, the particle size distribution of the solid electrolyte was measured by a laser diffraction scattering particle size distribution measuring device (trade name: MT3100II, manufactured by MicrotracBEL Corp.) The value of D50 (i.e., cumulative 50% particle diameter) of the measured particle size distribution was regarded as the average particle size. For the solid electrolyte of Example 1, the average particle diameter before the pulverization treatment was 0.7 μm, and the average particle diameter after the pulverization treatment was 0.62 μm.

### (BET Specific Surface Area)

The BET specific surface area was determined by the BET multipoint method using a device for the nitrogen gas adsorption method. For the solid electrolyte of Example 1, the BET specific surface area before the pulverization treatment was 3.2 m²/g, and the BET specific surface area after the pulverization treatment was 4.1 m²/g.

### (Analysis of Trace Components)

The trace components contained in the solid electrolyte were analyzed by EPMA. Specifically, the trace components were analyzed as follows. A sample (powder) of the solid electrolyte was attached and fixed to a conductive tape (sample was adhered and fixed in a range of 5 mm×5 mm), and the composition (quantitative) was investigated through compositional analysis by point analysis. Although not confirmed by the X-ray diffraction measurement, it was confirmed that Ti, Si, Cu, and Ga were contained in the solid electrolyte of Example 1. The content ratio of Ti was 0.003 at. %, the content ratio of Si was 0.005 at. %, the content ratio of Cu was 0.002 at. %, and the content ratio of Ga was 0.002 at. %.

### (Observation of Particle Shape)

The particle shape was observed using an SEM image of the solid electrolyte obtained in Example 1. The particles of the solid electrolyte confirmed from the SEM image had an elongated shape. It was also confirmed that particles having a particle diameter (major axis length) of 0.3 μm or more and 1 μm or less and an aspect ratio of 2.0 or more were included.

From the evaluation results of the solid electrolyte obtained in Example 1, the solid electrolyte produced by the production method of the present disclosure had a high ionic conductivity of 3.8 μS/cm. This ionic conductivity was higher than the ionic conductivity (about 1 μS/cm) of Li₃AlF₆ having a monoclinic crystal structure and synthesized by a solid-phase reaction from a fluoride raw material, so that the solid electrolyte of the present disclosure was confirmed to have excellent characteristics and be useful. The electronic conductivity was <1.0×10⁻⁹ μS/cm, and it was confirmed that the halide solid electrolyte was an ionic conductive solid electrolyte having no electron-conducting properties (i.e., having a negligible level of electronic conductivity).

From the X-ray diffraction pattern shown in FIG. 8A, for the solid electrolyte of Example 1, a first crystal phase represented by the composition formula (1): Li₃AlF₆ and having an orthorhombic crystal structure was confirmed. In addition, from the X-ray diffraction pattern shown in FIG. 8B, for the solid electrolyte of Example 1, in the X-ray diffraction pattern after the pulverization treatment, the peak changed to a broader peak than in the X-ray diffraction pattern before the pulverization treatment, and the progress of amorphization was confirmed. However, no new precipitate phase due to the pulverization treatment appeared. The changes in ionic conductivity, average particle diameter, and BET specific surface area before and after the pulverization treatment are as described in the explanation section for each evaluation item. From these results, it can be seen that the pulverization treatment may or may not necessarily be performed depending on the application of the solid electrolyte, etc., and the composition and the crystal phase of the solid electrolyte almost do not change regardless of the presence or absence of the pulverization treatment, so that excellent characteristics are maintained.

As shown above, according to the solid electrolyte of the present disclosure and its production method, a solid electrolyte that is difficult to synthesize by conventional production methods and that has higher ionic conductivity than Li₃AlF₆ having a monoclinic crystal structure and synthesized by a conventional production method, is soft, has excellent deformability, and is highly useful, can be realized. In addition, whereas the cost of fluoride raw materials used in conventional production methods is very high, inexpensive raw materials such as oxides are used in the production method of the present disclosure, so that the production cost of the solid electrolyte can be reduced. Therefore, the production method of the present disclosure possesses significant industrial applicability.

### INDUSTRIAL APPLICABILITY

The production method for a solid electrolyte according to the present disclosure can be used, for example, as a production method for a solid electrolyte for secondary batteries such as all-solid-state batteries for use in various electronic devices or automobiles.

What is claimed is:

1. A solid electrolyte comprising a first crystal phase represented by the following composition formula (1) and having an orthorhombic crystal structure,

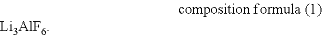

2. The solid electrolyte according to claim 1, wherein
the solid electrolyte includes a particle having a particle diameter of 1 μm or less.

3. The solid electrolyte according to claim 2, wherein
an average particle diameter of the solid electrolyte is 1 μm or less.

4. The solid electrolyte according to claim 1, wherein
the solid electrolyte includes a particle having a particle diameter of 0.3 μm or more.

5. The solid electrolyte according to claim 1, wherein
the solid electrolyte includes a particle having an aspect ratio of 2.0 or more.

6. The solid electrolyte according to claim 1, wherein
the solid electrolyte includes a particle having a free surface.

7. The solid electrolyte according to claim 1, wherein
the solid electrolyte further comprises a second crystal phase represented by the composition formula (1) and having a monoclinic crystal structure.

8. The solid electrolyte according to claim 7, wherein
the solid electrolyte includes
a first particle including the first crystal phase and not including the second crystal phase, and
a second particle including the second crystal phase, and
the second particle is softer than the first particle.

9. The solid electrolyte according to claim 1, wherein
the solid electrolyte further comprises an amorphous phase.

10. The solid electrolyte according to claim 1, wherein
the solid electrolyte further comprises at least one selected from the group consisting of Ti, Si, Cu, and Ga, as a secondary component.

11. A production method for the solid electrolyte according to claim 1, comprising
(A) mixing a raw material including at least one selected from the group consisting of an oxide of Li, a carbonate of Li, and a hydroxide of Li and at least one selected from the group consisting of an oxide of Al, a carbonate of Al, and a hydroxide of Al, and performing fluorination treatment on the mixed raw material.

12. The production method for the solid electrolyte according to claim 11, wherein
in the (A), the fluorination treatment on the raw material is performed by performing heat treatment on a fluorine-containing substance having thermal decomposition properties.

13. The production method for the solid electrolyte according to claim 12, wherein
the (A) includes
(A-1) mixing the raw material and the fluorine-containing substance, and
(A-2) fluorinating the raw material by performing heat treatment on a mixture including the raw material and the fluorine-containing substance obtained in the (A-1), to obtain the solid electrolyte.

14. The production method for the solid electrolyte according to claim 12, wherein
in the (A), fluorine gas is generated by performing heat treatment on the fluorine-containing substance, and the raw material is fluorinated by bringing the fluorine gas into contact with the raw material, to obtain the solid electrolyte.

15. The production method for the solid electrolyte according to claim 12, wherein
the fluorine-containing substance includes ammonium fluoride.

16. The production method for the solid electrolyte according to claim 12, wherein
the fluorine-containing substance includes a resin.

17. The production method for the solid electrolyte according to claim 11, further comprising
(B) performing pulverization treatment on the solid electrolyte obtained in the (A), after the (A).

18. A positive electrode material comprising the solid electrolyte according to claim 1.

19. A battery comprising a positive electrode including the positive electrode material according to claim 18.

20. A battery comprising:
a positive electrode;
a negative electrode; and
an electrolyte layer provided between the positive electrode and the negative electrode, wherein
at least one selected from the group consisting of the positive electrode, the negative electrode, and the electrolyte layer includes the solid electrolyte according to claim 1.
